(19) United States
(12) Patent Application Publication
(10) Pub. No.: US 2025/0315771 A1
(43) Pub. Date: Oct. 9, 2025

(54) FINANCIAL ADVISOR/INSURANCE AGENT MENTORING SOFTWARE

(71) Applicant: Steven Michael Helget, North Mankato, MN (US)

(72) Inventors: Steven Michael Helget, North Mankato, MN (US); John Andre Kaliski, Mankato, MN (US); Philip Howard Anderson, Burnsville, MN (US)

(21) Appl. No.: 19/170,947

(22) Filed: Apr. 4, 2025

Related U.S. Application Data
(63) Continuation of application No. PCT/US2025/023061, filed on Apr. 3, 2025.
(60) Provisional application No. 63/575,372, filed on Apr. 5, 2024.

(51) Int. Cl. G06Q 10/0639; G06Q 40/06; G06Q 40/08

(52) U.S. Cl. CPC G06Q 10/06398; G06Q 40/06; G06Q 40/08

(57) ABSTRACT

Included in the present disclosure is a method, including obtaining data associated with a metric of a user. In some embodiments, the method includes comparing the data to a benchmark associated with the metric, thereby determining a benchmark score. According to some embodiments, the method includes applying artificial intelligence (AI) to determine a course of action based on the benchmark score and demographic information. The course of action may include i) calibrating the benchmark, ii) determining an activity to adjust future data associated with the metric, or iii) both, so as to modify the benchmark score.

### CROSS-REFERENCE TO RELATED APPLICATIONS

The entire contents of the following application are incorporated herein by reference: PCT Application No. PCT/US25/23061; filed Apr. 3, 2025; and entitled FINANCIAL ADVISOR/INSURANCE AGENT MENTORING SOFTWARE.

The entire contents of the following application are incorporated herein by reference: U.S. Provisional Patent Application No. 63/575,372; filed Apr. 5, 2024; and entitled FINANCIAL ADVISOR/INSURANCE AGENT MENTORING SOFTWARE.

### Background

Financial advising has evolved significantly over time, shaped by changes in economic conditions, regulatory environments, and advancements in financial theory and technology. Historically, financial advisors and insurance agents have played a crucial role in helping individuals and organizations navigate complex financial landscapes, providing guidance on investment strategies, retirement planning, risk management, and wealth preservation.

Al Granum, a pioneering figure in the insurance and financial services industry, developed the One Card System, which is a client-building system. Granum's work made significant contributions to the profession with his innovative methods and principles. Central to Granum's approach was benchmarking success, a concept he advocated for as a means of measuring progress and evaluating performance. By setting clear, achievable benchmarks, financial advisors and insurance agents could track their own success and identify trends and areas for improvement. Another significant breakthrough of Granum's approach was giving advisors a roadmap for the activity that is required to build a predictably successful business through client building. The One Card System is primarily used for building a business with insurance clients (not investments), but the present disclosure incorporates both insurance and investments, as well as other sales related industries in which salespeople are client-building.

Granum's methods have had a lasting impact on the financial advisor and insurance agent professions, influencing generations of advisors to prioritize client relationships, setting goals, and continuously striving for improvement. His emphasis on client building, personalized service, and benchmarking success remains relevant today as financial advisors and insurance agents continue to adapt to changing market conditions and evolving client needs.

However, there are problems in the space of building a financial services business that are not addressed by Granum's One Card System. The present disclosure seeks to remedy these deficiencies as found in the prior art.

### SUMMARY

Included in the present disclosure is a method, including obtaining data associated with a metric of a user. In some embodiments, the method includes comparing the data to a benchmark associated with the metric, thereby determining a benchmark score. According to some embodiments, the method includes applying artificial intelligence (AI) to determine a course of action based on the benchmark score and demographic information. The course of action may include i) calibrating the benchmark, ii) determining an activity to adjust future data associated with the metric, or iii) both, so as to modify the benchmark score.

In some embodiments, the benchmark score includes subtracting the data from the benchmark, and a benchmark score that is greater than or equal to zero is associated with a better benchmark score. According to some embodiments, the benchmark score includes subtracting the data from the benchmark, and a benchmark score that is less than or equal to zero is associated with a better benchmark score. The benchmark score may include dividing the data by the benchmark, and a benchmark score that is greater than or equal to one may be associated with a better benchmark score. In some embodiments, the benchmark score includes dividing the data by the benchmark, and a benchmark score that is less than or equal to one is associated with a better benchmark score. According to some embodiments, the benchmark score includes forming an inequality between the data and the benchmark and returning a Boolean “true” when the data is greater than or equal to the benchmark and a Boolean “false” when the data is less than the benchmark, and a Boolean “true” is associated with a better benchmark score. The benchmark score may include forming an inequality between the data and the benchmark and returning a Boolean “true” when the data is less than or equal to the benchmark and a Boolean “false” when the data is greater than the benchmark, and a Boolean “true” is associated with a better benchmark

In some embodiments, modifying the benchmark score includes optimizing the benchmark score. According to some embodiments, the demographic information is related to the user. The demographic information may be related to another person with relation to the user. In some embodiments, the demographic information includes i) age, ii) gender, iii) race, iv) experience level, v) highest level of education, vi) marital status, vii) family status, viii) household income, ix) geographic location, x) occupation, xi) origin, or xii) combinations thereof.

According to some embodiments, the demographic information includes a collection of historical demographic information. The method may further include adding demographic information in real-time to the collection of historical demographic information based on the metric of the user. In some embodiments, the method further includes training the AI on i) the demographic information, ii) the collection of historical demographic information, or iii) combinations thereof.

According to some embodiments, the AI includes i) a regression model, ii) a large language model, iii) a decision tree, iv) a random forest, v) a gradient boosted machine learning model, vi) a support vector machine, vii) a Naïve Bayes model, viii) a k-means cluster, ix) a neural network, or x) combinations thereof. The regression model may include i) a linear regression, ii) a logistic regression, iii) a polynomial regression, or iv) combinations thereof. In some embodiments, the neural network includes i) a feed-forward network, ii) a convolutional neural network, iii) a deep neural network, iv) an autoencoder neural network, v) a generative adversarial network, vi) a recurrent network, or vii) combinations thereof. According to some embodiments, the recurrent network includes i) a long short-term memory network, ii) a bi-directional recurrent network, iii) a directional recurrent network, or iv) combinations thereof.

Obtaining data associated with the metric of the user may include input from the user. In some embodiments, obtaining data associated with the metric of the user includes automatically gathering the data via the AI.

According to some embodiments, the user is an advisor. The metric may include the advisor's i) activity patterns, ii) productivity, iii) skill set, iv) responsiveness to notifications, v) need to implement corrective actions, vi) personal savings goals, vii) professional savings goals, viii) major purchase goals, ix) professional production goals, x) personal financial position, xi) professional financial position, or xii) combinations thereof.

In some embodiments, the user is a manager. According to some embodiments, the metric includes i) a productivity of the manager, ii) activity patterns of the manager's one or more advisees, iii) common strengths of the manager's one or more advisees, iv) common weaknesses of the manager's one or more advisees, or v) combinations thereof.

The user may be an organization. In some embodiments, the metric corresponds to collective metrics of advisors and managers that are a part of the organization.

According to some embodiments, the method further includes applying the AI to identify i) trends, ii) relationships, or iii) both in the data with respect to the demographic information. The AI may be configured to identify when the trends are moving toward i) a better benchmark score, ii) a worse benchmark score, or iii) combinations thereof. In some embodiments, the AI compares the trends in the data to a collection of historical data.

According to some embodiments, the AI is configured to update a collection of historical data with the data with respect to the demographic information in real-time. The user may be a first user in a plurality of users, and the AI may be configured to update a collection of historical data based on data points associated with each user of the plurality of users with respect to the demographic information in real-time. In some embodiments, the AI is configured to update the course of action based on the collection of historical data.

According to some embodiments, determining the course of action includes using data associated with one or more better benchmark scores to provide instruction to the user when the data of the user is associated with a worse benchmark score. The AI may be configured to determine commonalities between users associated with better benchmark scores. In some embodiments, determining the course of action includes using the commonalities between users associated with better benchmark scores.

The course of action may be i) triggering training or ii) other remediation when the metric of the user is associated with a worse benchmark score. In some embodiments, the training is a corrective action. According to some embodiments, the AI is configured to determine a need for training in real-time.

The AI may be configured to create a presentation for the user. In some embodiments, the presentation is a video presentation. According to some embodiments, the presentation is interactive. The presentation may be tailored to the user based on i) the data, ii) the metric, iii) the benchmark score, iv) the user's demographics, or v) combinations thereof. In some embodiments, the AI is configured to provide training materials to the user.

According to some embodiments, the user is a manager, and the AI is configured to find materials explaining how to i) inspire, ii) motivate, iii) inform, iv) educate, v) improve skill sets, or vi) combinations thereof an advisor. The user may be a manager, and the AI may be configured to generate materials explaining how to i) inspire, ii) motivate, iii) inform, iv) educate, v) improve skill sets, or vi) combinations thereof an advisor.

In some embodiments, the user is an organization, and the AI is configured to find materials explaining how to i) inspire, ii) motivate, iii) inform, iv) educate, v) improve skill sets, or vi) combinations thereof a manager. According to some embodiments, the user is an organization, and the AI is configured to generate materials explaining how to i) inspire, ii) motivate, iii) inform, iv) educate, v) improve skill sets, or vi) combinations thereof a manager.

The materials may be i) videos, ii) processes, iii) articles, iv) websites, v) social media posts, vi) internal company posts, vii) podcasts, or viii) combinations thereof. In some embodiments, the user is a manager, and the AI is configured to facilitate a growth of the manager's i) training, ii) coaching, or iii) combinations thereof.

According to some embodiments, the metric is i) a time of interaction with a module of a software application, ii) a distribution of modules of a software application interacted with, iii) a usage pattern of interacting with modules of a software application, iv) an order of modules of a software application accessed, v) items within a module of a software application interacted, vi) a pattern of use of a software application, vii) a responsiveness to notifications, or viii) combinations thereof. The AI may be configured to improve the way in which the notifications are sent. In some embodiments, the AI is configured to customize the notifications to the user.

According to some embodiments, the AI is configured to inform the user when it would be profitable to hire an employee. The AI may be configured to change a culture of an organization. In some embodiments, the AI is configured to identify demographics associated with better benchmark scores for a given metric.

According to some embodiments, the AI is configured to identify advisors best suited to become managers based on one or more of the advisor's benchmark scores. The AI may be configured to identify advisors best suited to become managers based on a combination of the demographic information and one or more of the advisor's benchmark scores. In some embodiments, the AI is configured to predict i) a success or ii) a failure of an advisor based on skills displayed by the advisors.

According to some embodiments, the method further includes providing an instruction to the user based on the course of action determined by the AI.

Also included in the present disclosure is a non-transitory, computer-readable media, executable by a processor, and configured to cause the processor to perform the step of obtaining data associated with a metric of a user. In some embodiments, the non-transitory, computer-readable media is configured to cause the processor to perform the step of comparing the data to a benchmark associated with the metric, thereby determining a benchmark score. According to some embodiments, the non-transitory, computer-readable media is configured to cause the processor to perform the step of applying AI to determine a course of action based on the benchmark score and demographic information. The course of action may include i) calibrating the benchmark, ii) determining an activity to modify future data associated with the metric, or iii) both, so as to modify the benchmark score.

In some embodiments, the benchmark score includes subtracting the data from the benchmark, and a benchmark score that is greater than or equal to zero is associated with a better benchmark score. According to some embodiments, the benchmark score includes subtracting the data from the benchmark, and a benchmark score that is less than or equal to zero is associated with a better benchmark score. The benchmark score may include dividing the data by the benchmark, and a benchmark score that is greater than or equal to one may be associated with a better benchmark score. In some embodiments, the benchmark score includes dividing the data by the benchmark, and a benchmark score that is less than or equal to one is associated with a better benchmark score. According to some embodiments, the benchmark score includes forming an inequality between the data and the benchmark and returning a Boolean “true” when the data is greater than or equal to the benchmark and a Boolean “false” when the data is less than the benchmark, and a Boolean “true” is associated with a better benchmark score. The benchmark score may include forming an inequality between the data and the benchmark and returning a Boolean “true” when the data is less than or equal to the benchmark and a Boolean “false” when the data is greater than the benchmark, and a Boolean “true” is associated with a better benchmark score.

In some embodiments, modifying the benchmark score includes optimizing the benchmark score. According to some embodiments, the demographic information is related to the user. The demographic information may be related to another person with relation to the user. In some embodiments, the demographic information includes i) age, ii) gender, iii) race, iv) experience level, v) highest level of education, vi) marital status, vii) family status, viii) household income, ix) geographic location, x) occupation, xi) origin, or xii) combinations thereof.

According to some embodiments, the demographic information includes a collection of historical demographic information. The non-transitory, computer-readable media may further cause the processor to perform the step of adding demographic information in real-time to the collection of historical demographic information based on the metric of the user. In some embodiments, the non-transitory, computer-readable media further causes the processor to perform the step of training the AI on i) the demographic information, ii) the collection of historical demographic information, or iii) combinations thereof.

According to some embodiments, the AI includes i) a regression model, ii) a large language model, iii) a decision tree, iv) a random forest, v) a gradient boosted machine learning model, vi) a support vector machine, vii) a Naïve Bayes model, viii) a k-means cluster, ix) a neural network, or x) combinations thereof. The regression model may include i) a linear regression, ii) a logistic regression, iii) a polynomial regression, or iv) combinations thereof. In some embodiments, the neural network includes i) a feed-forward network, ii) a convolutional neural network, iii) a deep neural network, iv) an autoencoder neural network, v) a generative adversarial network, vi) a recurrent network, or vii) combinations thereof. According to some embodiments, the recurrent network includes i) a long short-term memory network, ii) a bi-directional recurrent network, iii) a directional recurrent network, or iv) combinations thereof.

Obtaining data associated with the metric of the user may include input from the user. In some embodiments, obtaining data associated with the metric of the user includes automatically gathering the data via the AI.

According to some embodiments, the user is an advisor. The metric may include the advisor's i) activity patterns, ii) productivity, iii) skill set, iv) responsiveness to notifications, v) need to implement corrective actions, vi) personal savings goals, vii) professional savings goals, viii) major purchase goals, ix) professional production goals, x) personal financial position, xi) professional financial position, or xii) combinations thereof.

In some embodiments, the user is a manager. According to some embodiments, the metric includes i) a productivity of the manager, ii) activity patterns of the manager's one or more advisees, iii) common strengths of the manager's one or more advisees, iv) common weaknesses of the manager's one or more advisees, or v) combinations thereof.

The user may be an organization. In some embodiments, the metric corresponds to collective metrics of advisors and managers that are a part of the organization.

According to some embodiments, the non-transitory, computer-readable media further causes the processor to perform the step of applying the AI to identify i) trends, ii) relationships, or iii) both in the data with respect to the demographic information. The AI may be configured to identify when the trends are moving toward i) a better benchmark score, ii) a worse benchmark score, or iii) combinations thereof. In some embodiments, the AI compares the trends in the data to a collection of historical data.

According to some embodiments, the AI is configured to update a collection of historical data with the data with respect to the demographic information in real-time. The user may be a first user in a plurality of users, and the AI may be configured to update a collection of historical data based on data points associated with each user of the plurality of users with respect to the demographic information in real-time. In some embodiments, the AI is configured to update the course of action based on the collection of historical data.

According to some embodiments, determining the course of action includes using data associated with one or more better benchmark scores to provide instruction to the user when the data of the user is associated with a worse benchmark score. The AI may be configured to determine commonalities between users associated with better benchmark scores. In some embodiments, determining the course of action includes using the commonalities between users associated with better benchmark scores.

The course of action may be i) triggering training or ii) other remediation when the metric of the user is associated with a worse benchmark score. In some embodiments, the training is a corrective action. According to some embodiments, the AI is configured to determine a need for training in real-time.

The AI may be configured to create a presentation for the user. In some embodiments, the presentation is a video presentation. According to some embodiments, the presentation is interactive. The presentation may be tailored to the user based on i) the data, ii) the metric, iii) the benchmark score, iv) the user's demographics, or v) combinations thereof. In some embodiments, the AI is configured to provide training materials to the user.

According to some embodiments, the user is a manager, and the AI is configured to find materials explaining how to i) inspire, ii) motivate, iii) inform, iv) educate, v) improve skill sets, or vi) combinations thereof an advisor. The user may be a manager, and the AI may be configured to generate materials explaining how to i) inspire, ii) motivate, iii) inform, iv) educate, v) improve skill sets, or vi) combinations thereof an advisor.

In some embodiments, the user is an organization, and the AI is configured to find materials explaining how to i) inspire, ii) motivate, iii) inform, iv) educate, v) improve skill sets, or vi) combinations thereof a manager. According to some embodiments, the user is an organization, and the AI is configured to generate materials explaining how to i) inspire, ii) motivate, iii) inform, iv) educate, v) improve skill sets, or vi) combinations thereof a manager.

The materials may be i) videos, ii) processes, iii) articles, iv) websites, v) social media posts, vi) internal company posts, vii) podcasts, or viii) combinations thereof. In some embodiments, the user is a manager, and the AI is configured to facilitate a growth of the manager's i) training, ii) coaching, or iii) combinations thereof.

According to some embodiments, the metric is i) a time of interaction with a module of a software application, ii) a distribution of modules of a software application interacted with, iii) a usage pattern of interacting with modules of a software application, iv) an order of modules of a software application accessed, v) items within a module of a software application interacted, vi) a pattern of use of a software application, vii) a responsiveness to notifications, or viii) combinations thereof. The AI may be configured to improve the way in which the notifications are sent. In some embodiments, the AI is configured to customize the notifications to the user.

According to some embodiments, the AI is configured to inform the user when it would be profitable to hire an employee. The AI may be configured to change a culture of an organization. In some embodiments, the AI is configured to identify demographics associated with better benchmark scores for a given metric.

According to some embodiments, the AI is configured to identify advisors best suited to become managers based on one or more of the advisor's benchmark scores. The AI may be configured to identify advisors best suited to become managers based on a combination of the demographic information and one or more of the advisor's benchmark scores. In some embodiments, the AI is configured to predict i) a success or ii) a failure of an advisor based on skills displayed by the advisors.

According to some embodiments, the non-transitory, computer-readable media further causes the processor to perform the step of providing an instruction to the user based on the course of action determined by the AI.

The foregoing, and other features and advantages of the invention, will be apparent from the following, more particular description of the preferred embodiments of the invention, the accompanying drawings, and the claims

### BRIEF DESCRIPTION OF DRAWINGS

These and other features, aspects, and advantages are described below with reference to the drawings, which are intended to illustrate, but not to limit, the invention. In the drawings, like characters denote corresponding features consistently throughout similar embodiments.

FIG. 1 illustrates a flowchart depicting a business book sales cycle module, according to some embodiments.

FIGS. 2-5 illustrate more detailed components of the flowchart depicting a business book sales cycle module, according to some embodiments.

FIG. 6 illustrates a flowchart depicting a business book advisor workflow module, according to some embodiments.

FIG. 7 illustrates a flowchart depicting another example of a business book advisor workflow module, according to some embodiments.

FIG. 8 illustrates a flowchart depicting business life modules, according to some embodiments.

FIG. 9 illustrates a flowchart depicting personal life modules, according to some embodiments.

FIG. 10 illustrates a flowchart depicting an activity module, according to some embodiments.

FIG. 11 illustrates a flowchart depicting a business book module, according to some embodiments.

FIG. 12 illustrates a flowchart depicting a product sales module, according to some embodiments.

FIG. 13 illustrates a flowchart depicting a clients/prospects module, according to some embodiments.

FIG. 14 illustrates a flowchart depicting a reports module, according to some embodiments.

FIG. 15 illustrates a flowchart depicting a production module, according to some embodiments.

FIG. 16 illustrates a flowchart depicting a production goal expiration corrective action process, according to some embodiments.

FIG. 17 illustrates a flowchart depicting savings goal modules, according to some embodiments.

FIG. 18 illustrates a flowchart depicting a savings goal expiration corrective action process, according to some embodiments.

FIG. 19 illustrates a flowchart depicting cash flow modules, according to some embodiments.

FIG. 20 illustrates a flowchart depicting balance sheet modules, according to some embodiments.

FIG. 21 illustrates a flowchart depicting a handle preemptive event process, according to some embodiments.

FIG. 22 illustrates a flowchart depicting command central modules, according to some embodiments.

FIG. 23 illustrates a flowchart depicting a command central activity module, according to some embodiments.

FIG. 24 illustrates a flowchart depicting command central insurance and investment modules, according to some embodiments.

FIG. 25 illustrates a flowchart depicting a command central reports module, according to some embodiments.

FIG. 26 illustrates a flowchart depicting a command central financial module, according to some embodiments.

FIG. 27 illustrates a flowchart depicting a command central strategy module, according to some embodiments.

FIG. 28 illustrates a flowchart depicting a manager overview module, according to some embodiments.

FIG. 29 illustrates a flowchart depicting a manager tools module, according to some embodiments.

FIG. 30 illustrates a flowchart depicting a benchmark scores calculator module, according to some embodiments.

FIG. 31 illustrates a flowchart depicting an Advisor Profile create/edit module, according to some embodiments.

FIG. 32 illustrates a flowchart depicting an Advisor Profile execution module, according to some embodiments.

FIG. 33 illustrates a flowchart depicting a manager advisees module, according to some embodiments.

FIG. 34 illustrates a flowchart depicting a back-office processing module, according to some embodiments.

FIG. 35 illustrates a flowchart depicting an administrator overview module, according to some embodiments.

FIG. 36 illustrates a site admin module, according to some embodiments.

FIG. 37 illustrates a user admin module, according to some embodiments.

FIG. 38 illustrates a reporting module, according to some embodiments.

FIGS. 39-44 illustrate graphical representations of a graphical user interface, according to some embodiments.

FIG. 45 illustrates a flowchart depicting a method of using artificial intelligence (AI) to determine a course of action, according to some embodiments.

FIG. 46 illustrates a flowchart depicting additional methods of using AI to determine a course of action, according to some embodiments.

### DETAILED DESCRIPTION OF THE INVENTION

Throughout the present disclosure, the terms “user,” “advisor,” and “agent” are used interchangeably. It is understood that, in some embodiments, the user may be a manager, such as an advisor's manager. In order to distinguish this type of user from an advisor and avoid obfuscation of what type of user is being referred to, the term “manager” will always be used when referring to a manager.

Additionally, throughout the present disclosure, references are made to the “demographics” of the user when taking into account their different benchmarks for relevant performance metrics and activity ratios. These metrics and ratios may be used in conjunction with Al Granum's One Card System, or personal, corporate, or historical metrics and ratios. It is understood that, while not explicitly stated each time “demographics” are mentioned, these “demographics” may include but are not limited to the age, gender, race, experience level, highest level of education, marital status, family status, occupation, household income, geographic location, or origin of each user and/or the user's client base. Origin may refer to how an individual started their career. Using an advisor as an example, an advisor origin may be an advisor who served an internship and became a full-time advisor, an advisor who was in a different career before becoming a full-time advisor, an advisor from a different firm (e.g., a financial firm), etc.

As used herein, a “benchmark score” may represent any form of comparison between data obtained from a user associated with a metric, and a benchmark associated with the metric. This may include dividing the data by the benchmark and obtaining a value (e.g., a benchmark score), where a value greater than or equal to one is indicative of the data being greater than the benchmark, and is therefore associated with a higher, or better, benchmark score, and where a value less than one is indicative of the data being less than the benchmark and is therefore associated with a lower, or worse, benchmark score. In some embodiments, this includes subtracting the benchmark from the data to obtain a value (e.g., a benchmark score), where a value greater than or equal to zero is indicative of the data being greater than the benchmark and is therefore associated with a higher, or better, benchmark score, and where a value less than zero is indicative of the data being less than the benchmark, and is therefore associated with a lower, or worse, benchmark score. According to some embodiments, this includes comparing the data to the benchmark and returning a Boolean “true” or “false,” (e.g., a benchmark score), where the Boolean returns “true” when the data is greater than or equal to the benchmark and “false” when the data is less than the benchmark, and where a “true” value is associated with a higher, or better, benchmark score, and where a “false” value is associated with a lower, or worse, benchmark score. In some embodiments, this may include correlating the benchmark as a threshold and further determining whether data associated with the metric exceeds, meets, or falls short of the threshold (e.g., benchmark associated with the metric), wherein said exceeding, meeting, or falling short corresponds to a benchmark score.

In additional or alternative embodiments, it may be desirable for a user to have data that is lower than the benchmark. In such examples, this may include dividing the data by the benchmark and obtaining a value, where a value less than or equal to one is indicative of the data being less than the benchmark, and is therefore associated with a lower, or better, benchmark score, and where a value higher than one is indicative of the data being higher than the benchmark and is therefore associated with a higher, or worse, benchmark score. In some embodiments, this includes subtracting the benchmark from the data, where a value less than or equal to zero is indicative of the data being less than the benchmark, and is therefore associated with a lower, or better, benchmark score, and where a value greater than zero is indicative of the data being higher than the benchmark and is therefore associated with a higher, or worse, benchmark score. According to some embodiments, this includes comparing the data to the benchmark and returning a Boolean “true” or “false,” where the Boolean returns “true” when the data is less than or equal to the benchmark and “false” when the data is greater than the benchmark, and where a “true” value is associated with a lower, or better, benchmark score, and where a “false” value is associated with a higher, or worse, benchmark score.

For ease of comprehension, the present disclosure will refer to higher benchmark scores being associated with better benchmark scores. It is understood that, in some embodiments, lower benchmark scores are associated with better benchmark scores.

Furthermore, as used herein, an “advisor” refers to a specific user, and an “advisee” refers to any advisor/user working under the supervision of a manager. In some embodiments, a user may be both an advisor and an advisee simultaneously. For example, the user may be an advisor, mentoring and/or advising a client, as well as being mentored/coached by a manager, thereby making the user that manager's advisee at the same time.

Further, throughout the present disclosure, references are made to “artificial intelligence” (AI). As used herein, AI may be used to mean any type of artificial intelligence, including but not limited to regression models (e.g., linear regression, logistic regression, polynomial regression, etc.), large language models, decision trees, random forests, gradient boosted machine learning models, support vector machines, Naïve Bayes models, k-means clusters, and/or neural networks (e.g., feed-forward networks, convolutional neural networks, deep neural networks, autoencoder neural networks, generative adversarial networks, and/or recurrent networks (e.g., long short-term memory networks, bi-directional recurrent networks, deep-bi-directional recurrent networks) or combinations thereof.

The software, as detailed in the present disclosure in combination with AI, may also be capable of setting benchmarks for advisors and managers based on specific sales targets, such as insurance policies sold, new clients attained, new assets under management, and insurance premiums sold. These benchmarks may be key information for advisors and managers who want to increase their performance.

By way of example, what activities and ratios are required for advisors to increase their number of policies sold by a specific number (e.g., 100 policies sold per year to 150 policies sold per year) or by a specific percentage (e.g., 50 percent increase in policies sold per year). By way of another example, what activities and ratios are required for advisors to increase their number of new clients by a specific number (e.g., 50 new clients per year to 75 new clients per year) or by a specific percentage (e.g., 50 percent increase in new clients per year). By way of a further example, what activities and ratios are required for advisors to increase their value of premium sold by a specific number (e.g., $200,000 of premium sold per year to $400,000 of premium sold per year) or by a specific percentage (e.g., 100 percent increase in value of premium sold per year). By way of a fourth example, what activities and ratios are required for advisors to increase their value of new assets under management by a specific number (e.g., $10 million of new assets under management per year to $20 million of new assets under management per year) or by a specific percentage (e.g., 100 percent increase in value of new assets under management per year).

In some embodiments, the software and AI (e.g., via a machine-learning algorithm) may determine demographic-specific benchmarks. Benchmarks existing in previous solutions are the same for every advisor, regardless of their demographics. Demographic-specific benchmarking may allow for more targeted and pinpointed training (i.e., when the manager and/or organization is onboarding new advisors) and/or coaching (i.e., after the advisors have been trained and are receiving ongoing instruction) strategies specific to each individual advisor. Additionally, AI may be able to advise on the demographic-specific coaching and/or mentoring strategies that should be used.

In some embodiments, the AI can advise the organization and its managers on what training strategies should or should not be implemented, based on the strengths and weaknesses of advisors in different training classes (e.g., starting year based (2021 vs. 2022 vs. 2023 vs. 2024, etc.) and/or length of tenure based (first year vs. second year vs. third year, vs. fourth year, etc.)). For example, if one class showed strength in phoning, and a second class showed strength in closing business, the organization and/or manager may look back at the training strategies implemented for each class and continue the training strategy in the category the class of advisors showed strength in, and stop using the training strategies associated with the skills that the advisors either showed weakness in or just less strength than other classes. The AI may enable the organization and managers to make these connections when it would otherwise be impossible for a human to detect such discrepancies.

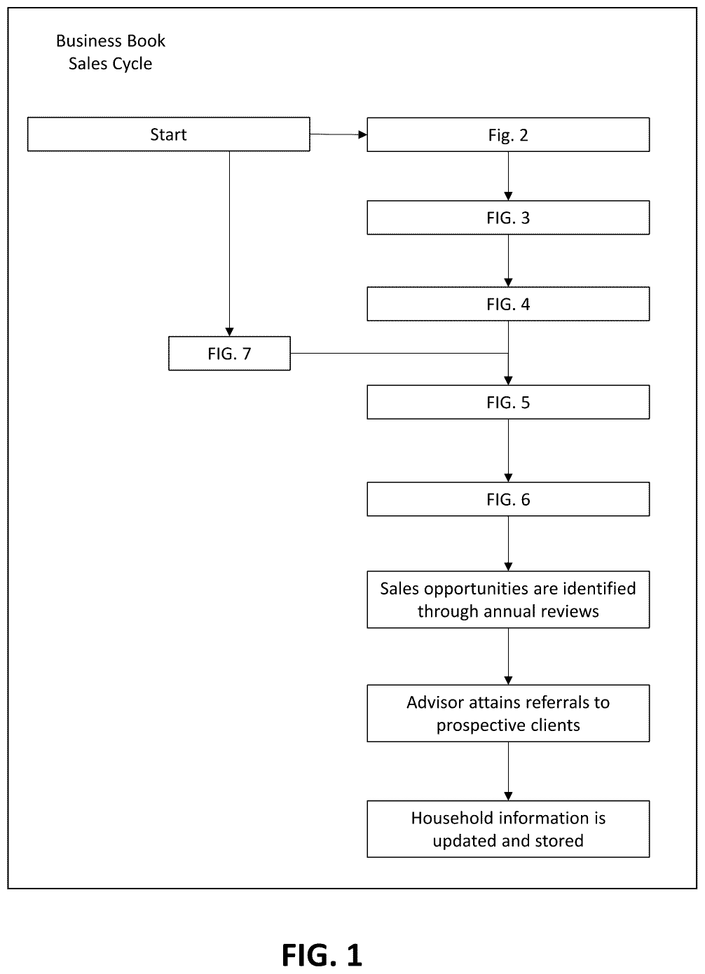

FIGS. 1-7 provide example embodiments of a sales cycle and workflow as an advisor takes the prospective client through the sales cycle. FIGS. 1-7, as detailed further below, may be at least partially reflective of the standard industry practice of the sales cycle, and are included herein to reflect improvements that the system of the present disclosure will support this sales cycle and workflow.

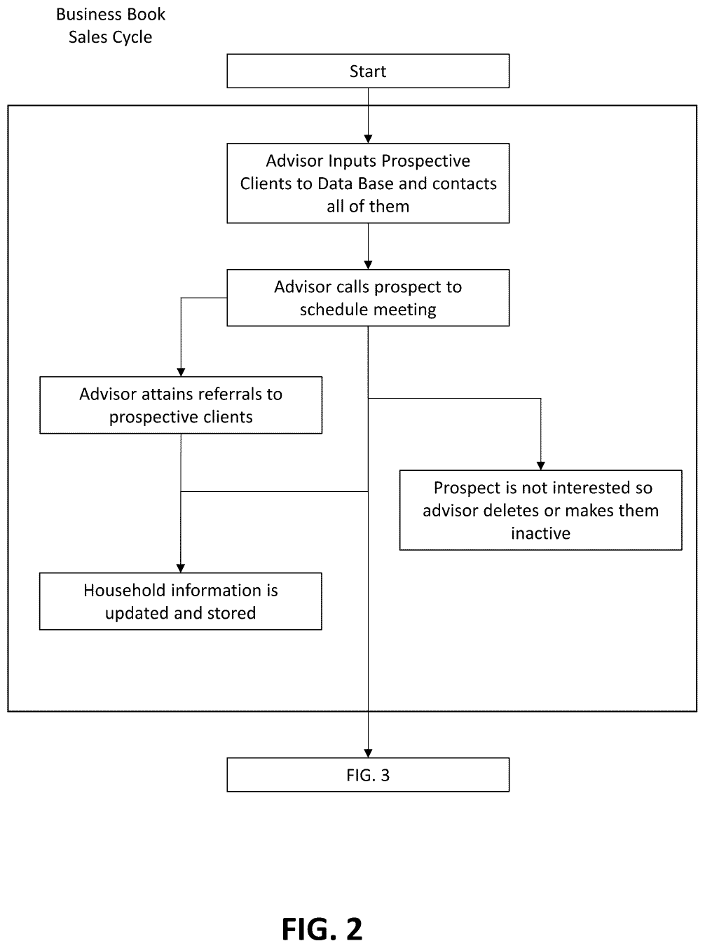

FIG. 1 illustrates a flowchart depicting a business book sales cycle module, according to some embodiments. The business book sales cycle is depicted in greater detail in FIGS. 2-5, but generally, eventually, it ends with sales opportunities for prospective clients becoming closed business and prospects/households becoming active clients. From there, sales opportunities may be identified through annual review meetings. Throughout this process, an advisor may attain referrals to prospective clients. Finally, household information about such a prospective client, as well as active clients, may be updated and stored.

FIG. 2 illustrates a possible first step in a business book sales cycle module. In this embodiment, an advisor (or user) may input a number of prospective clients into a database and subsequently contact these prospective clients. This contact may occur in the form of the advisor calling the prospective client to schedule a discovery meeting. Throughout this step, the advisor may attain referrals to other prospective clients. After obtaining referrals to prospective clients, or immediately after inputting and contacting the prospective clients in the database, the household information for the prospective clients may be updated and stored. If the prospect is not interested, the user may delete them from the database or make them inactive.

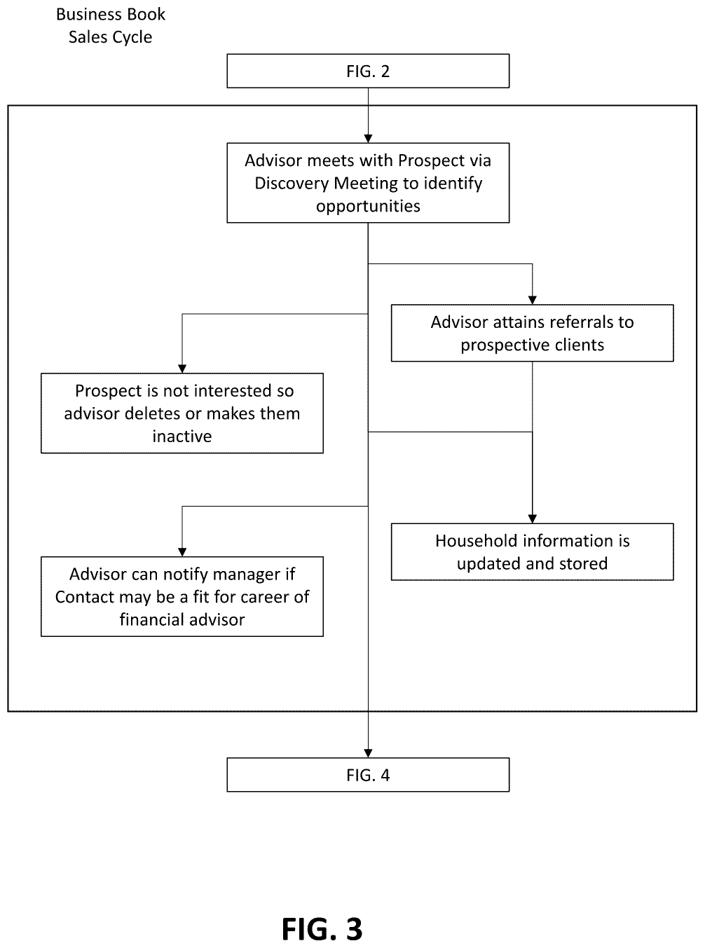

FIG. 3 illustrates a possible second step in a business book sales cycle module. In this embodiment, the advisor meets with prospective clients during a discovery meeting in order to identify sales opportunities. Throughout this step, the advisor may attain referrals to prospective clients. After obtaining referrals to prospective clients or immediately after meeting with prospective clients during a discovery meeting, the household information for the prospective clients may be updated and stored. If the prospect is not interested in working with the advisor, the user may delete them from the database or make them inactive. In some embodiments, the business book sales cycle modules include the advisor notifying the manager if a contact may be a fit for a career in the financial services industry.

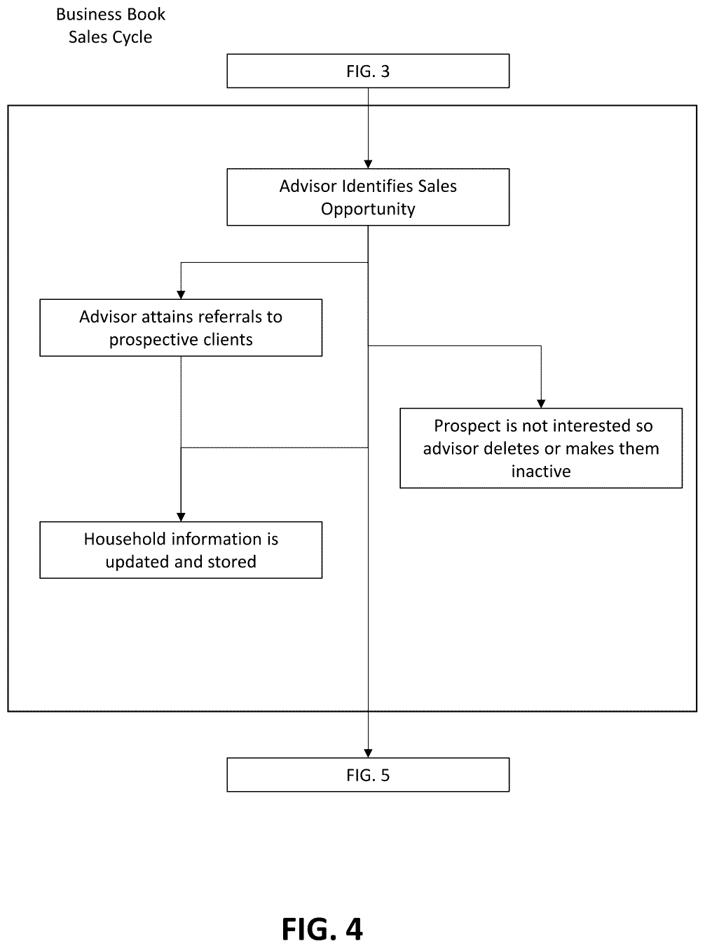

FIG. 4 illustrates a possible third step in a business book sales cycle module. In this embodiment, the advisor identifies sales opportunities. Throughout this step, the advisor may obtain referrals to prospective clients. After obtaining referrals to prospective clients or immediately after identifying sales opportunities, the household information for the prospective clients may be updated and stored. If the prospect is not interested in working with the advisor, the user may delete them from the database or make them inactive.

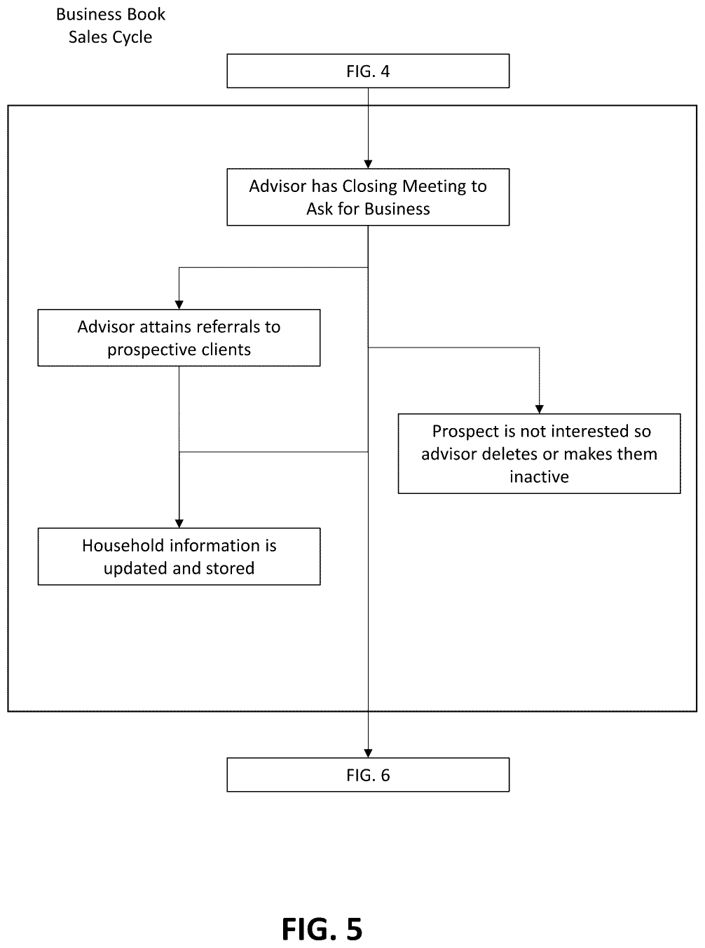

FIG. 5 illustrates a possible fourth step in a business book sales cycle module. In this embodiment, the advisor has a closing meeting to ask the prospective client for business. Throughout this step, the advisor may obtain referrals to prospective clients. After obtaining referrals to prospective clients or immediately after the closing meeting to ask the prospective client for business, the household information for the prospective clients may be updated and stored. If the prospect is not interested, the user may delete them from the database or make them inactive.

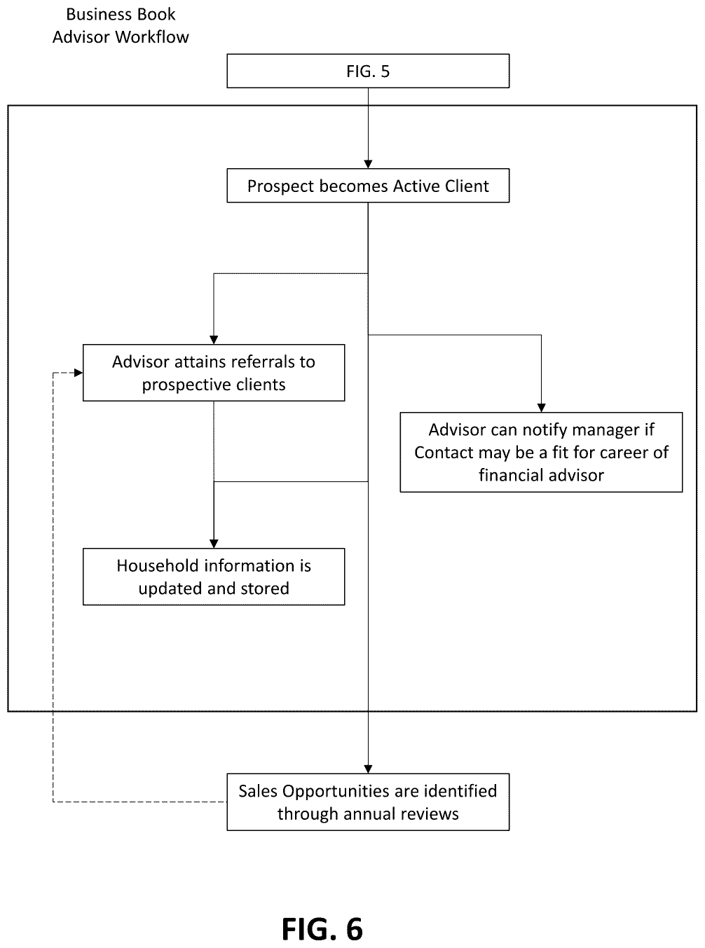

FIG. 6 illustrates a business book advisor workflow module. In this embodiment, the prospective client becomes or already is an active client. Throughout this workflow, the advisor may obtain referrals to prospective clients. After obtaining referrals to prospective clients or immediately after the prospective client becomes an active client, the household information may be updated and stored. Finally, new sales opportunities are identified through annual reviews, as detailed in FIG. 1 above. After new sales opportunities are identified through annual reviews, the user may return to the step of the business book advisor sales cycle as detailed in FIG. 5 above. In some embodiments, the business book sales cycle modules include the advisor notifying the manager if a contact may be a fit for a career in the financial services industry.

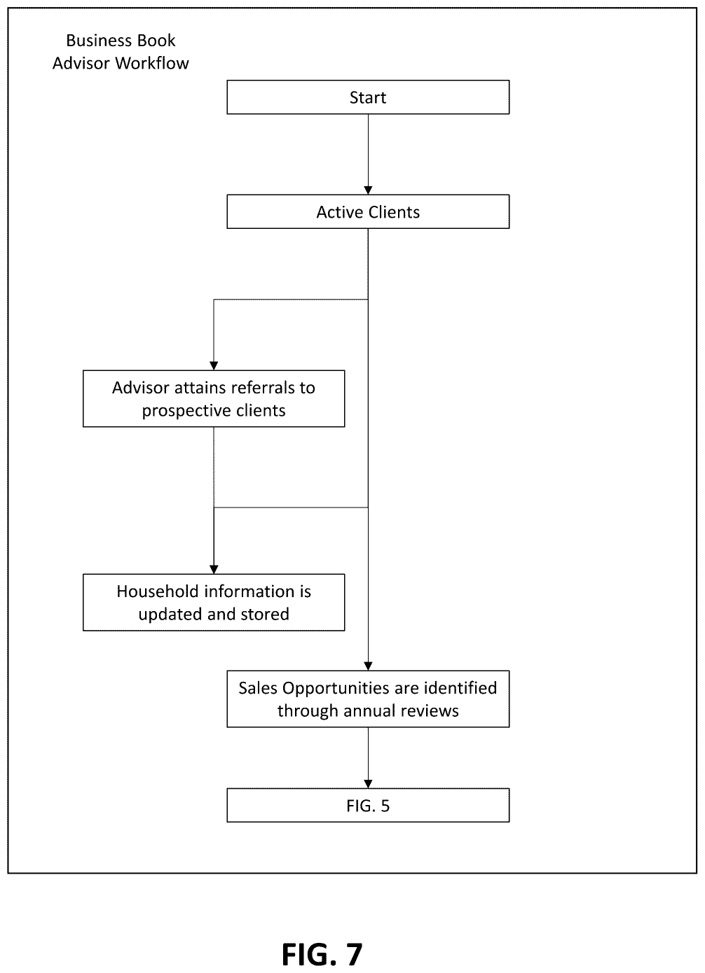

FIG. 7 illustrates another example of a business book advisor workflow module. In this embodiment, the user may start with active clients immediately. Throughout this workflow, the advisor may obtain referrals to prospective clients. After obtaining referrals to prospective clients or immediately after the advisor closes additional business, the household information may be updated and stored. New sales opportunities are identified through annual review meetings, as detailed in FIG. 1 above. After these new sales opportunities are identified through annual review meetings, the user may return to the step of the business book sales cycle module as detailed in FIG. 5 above.

Current systems in the field of technology for generating and providing information related to financial advisors' and insurance agents' business and personal lives, along with their extended team, rely on outdated technology.

The present system may include an embedded virtual coach that uses individualized advisor data to identify strengths and shortcomings in both the advisor's and manager's performance and/or skill sets and make real-time recommendations for proactive steps to mitigate pending problem areas. In some embodiments, this virtual coach notifies both the advisors and their managers and the organization when such shortcomings need to be addressed.

The virtual coach may accomplish tasks that include but are not limited to analysis of activities required to accomplish an advisor's goals, projections of an advisor's outcomes given current and historical activities and ratios, adjustments needed to be made for an advisor to accomplish their goals, and determinations of areas of improvement for their advisors. Such a virtual coach may free a significant amount of time for managers to work with their advisors on sales language, skill sets, client building, and business planning strategies. Many managers may feel uncomfortable or have difficulty holding conversations with their advisors about any potential negative trajectories of their performance and consequent financial situations. The systems of the present disclosure track and project these financial details and can automate informing these advisors while keeping the managers in the know. This information may be summarized and used to evaluate the manager's performance in mentoring their advisees. The information may also be summarized to evaluate company trends, strengths, weaknesses, and the effectiveness of company initiatives and training strategies.

Additionally, the systems of the present disclosure facilitate the formation of realistic goals for these advisors. In some embodiments, the system will notify the advisor if their sales goals do not align with the amount of income needed to pay their expenses and/or achieve their savings and/or major purchase goals. This may help to ensure the advisor's personal and business lives are in alignment for meeting any goals they may have, and that the advisor is financially secure if sales goals are achieved.

AI and generative AI technology may additionally be implemented into the systems of the present disclosure. This may include the use of data collection for analysis of the system-wide performance of the user, the user's manager, and/or the organization. The AI (as described herein) may use a machine-learning algorithm to process the data collection, wherein the data collection may be continuously receiving information based on real-time performance (e.g., by the user, user's manager, other users in the organization), such that the machine-learning algorithm is able to process said continuous updates in real-time. As a greater number of advisors, managers, and organizations use the system, the data pool that generative AI is able to mine for information grows, increasing generative AI's capacity for guiding these advisors, managers, and organizations on actions they can take to maximize success.

Generative AI begins with training the AI using historical data in order to teach the AI patterns and relationships that predict success within this field. The AI must be continuously and periodically retrained to validate the AI's ability to integrate incoming data and refine the algorithms being used, thereby increasing the accuracy of its predictions. This historical and updated data may be combined with application programming interfaces (APIs) and existing financial service databases to further improve the AI's predictive results.

Elements of the type of data being collected and stored are detailed and described in the foregoing figures and present disclosure. This may include an advisor's activity, activity patterns, productivity, sales, skill sets, responsiveness to notifications, and the need to implement corrective actions. This may also include the productivity of a manager, productivity of a manager's advisees, activity patterns of the manager's advisees, and common strengths and weaknesses of these advisees being mentored/trained/coached by this single manager. Generative AI may additionally serve to customize action plans for each advisor, manager, and organization based on corrective actions needed—either for the manager, organization, or their advisees.

At the organizational level, metrics and information about the full team, including the managers and advisors, may be pooled to develop a large quantity of historical data. The AI may then be able to direct the organization as a whole in a beneficial direction based on these metrics.

Further examples of incorporation of generative AI into the features of the present disclosure include the collection and use of data pertaining to on-page (module) usage—that is, time, distribution, and usage patterns—for both the advisor modules and the manager modules. This may include identifying module-to-module access patterns, module usage, timing, ordering, and items that are interacted with within a module. This data could then be used to determine differences between successful and unsuccessful advisors, managers, and company strategies and/or initiatives. This may allow advisors, managers, and the organization to share best practices and strategies. By way of example, if a manager's advisees are performing better than the benchmarks for closing business, that manager can share strategies with managers whose advisees are underperforming benchmarks for closing business. By way of another example, if a manager's advisees excel at scheduling meetings, that manager can share strategies with the entire organization.

By way of example, because benchmarks are used to measure success for advisors and managers, generative AI is able to determine what patterns of system usage are associated with a successful advisor or manager. The AI may then take these patterns of system usage to develop a plan of corrective action for those advisors or managers who are less successful, in order to give them the capacity to implement these successful strategies. Because success states are not binary—that is, one successful person may be more successful than a second successful person—generative AI may, through the collection of data over time, determine the optimal method of using the presently disclosed system, so as to help determine an optimal course of action for a given advisor and/or manager to become more successful with respect to their benchmark scores (i.e., skills and/or performance and/or outcomes). AI may be able to look back at advisors and managers who succeeded in making it in their careers in comparison to those who failed and/or left their careers (careers pertaining to the present disclosure) and understand commonalities between both groups. These commonalities may then be used to better understand the most important factors that dictate advisors and/or managers who make this their career versus those who do not.

Additional examples of incorporation of generative AI into the features of the present disclosure include the collection and use of data pertaining to session-level usage. This data may include how frequently an advisor or manager uses the present system, what days of the week this usage is occurring, how long the advisor or manager continues to interact with the system in a single session, and how many modules are accessed by this advisor or manager in a single session.

Similar to the on-page usage data collection detailed above, this session-level usage information may permit generative AI to determine what patterns of session-level usage are associated with success—and, further, what patterns of session-level usage may be considered optimal usage of the system within a single session.

Still further examples of incorporation of generative AI into the features of the present disclosure include the collection and use of data pertaining to advisor and manager responsiveness to system-level, manager-level, and corporate-level notifications. This may include assessing how quickly advisors and managers take action on recommendations and notifications sent by the system. In some embodiments, this includes recommendations and notifications relative to advisors, managers, and corporations identifying weaknesses and shortcomings.

Generative AI may improve this notification and recommendation functionality. By using the data generated within the present system, the AI may improve the way in which notifications and recommendations are sent to the advisor, manager, and company (i.e., frequency, trigger events, etc.).

Because the present system may already collect the data to recommend corrective actions, training, and mentoring or coaching, generative AI is provided with a large pool of data to provide solutions to problems that advisors, managers, and organizations may not even realize exist. This may include the use of mathematical algorithms to identify relationships, such as those based on variables of demographics, that humans may miss due to preconceived biases.

By way of example, for advisors, when a ratio is underperforming in comparison to a benchmark, the AI may modify several previous relationships so as to help determine an updated course of action for a given advisor and/or adjust any previous benchmarks associated with the advisor and their respective demographic information (e.g., demographic factors, demographic data, etc.). In some cases, adjusting the previous benchmarks will further facilitate other advisors having similar metrics (as described herein).

In some cases, the AI may trigger coaching to improve the skill associated with this ratio. The AI may automate the real-time teaching and training needed to correct an advisor's, manager's, and organization's performance issues. In some embodiments, if an advisor's activity is low, motivational coaching may be triggered. The AI may create natural language dialogue, motivational videos, and/or reuse from or customize other resources to which the AI has access.

In some embodiments, generative AI may create an interactive video presentation that is tailored to the individual receiving the presentation based on that individual's data. The AI may create an avatar for these purposes, in order to interact with the individual in a more meaningful way. Such interactive videos may be dispatched on-demand, in regular intervals, or based on some triggering event like failing to meet a benchmark. In this way, the individual and their manager may have their time freed up by the AI taking such tasks and conveyance of messages off of their hands.

According to some embodiments, when cash flow (either current, historical, or projected cash flow) is not at necessary values, this is indicative of an advisor heading toward a bad financial position. Generative AI may be able to provide training materials and instructions on how the advisor can increase and improve their sales, generate more cash flow, and, in turn, improve their projected financial position. Similarly, when activity follow-through of an advisor is underperforming the advisor's activity commitment, the AI may redirect the advisor to improve this metric through instructing the advisor on how to set more attainable activity commitments.

As an additional embodiment, when advisors fall below their activity commitments, their manager may need to provide inspiration to them. The system may include generative AI for this corrective action, which may serve to generate and/or find videos and processes that explain how to best inspire or motivate these advisors. These videos and processes may be specific to the area in which the advisor is struggling. For example—if an advisor is consistently calling fewer prospects than their “prospect call commitment,” the AI may be able to tell the manager that the advisee is hesitant to make calls and create and/or find videos or articles that explain how many people do not have a financial advisor and/or provide stories of people who died without life insurance, made mistakes with their investment portfolio, etc.

Consistent problems, such as managers allowing advisors to head down a negative path for too great a length of time, or too often, may be identified by the AI. This would both identify a recurring problem to the manager so they can make changes to prevent further recurrence of these issues, as well as identify if this is a recurring problem to corporate so that corrective action may be taken on the manager if deemed necessary.

Generative AI may also take this one step further. If a manager's advisees are consistently underperforming benchmarks in specific areas (i.e., scheduling meetings, closing business, getting referrals, etc.), generative AI may be able to facilitate the growth of the manager's training and coaching skill sets. Yet another step further, generative AI may be able to provide corrective action and training to the manager's advisees without the manager's interference, automating these activities.

Similar to measuring the advisor's success and skill sets as detailed above, generative AI may also analyze the success and skill set of a manager and facilitate corrective actions and the improvement of their skills. Generative AI may use the data generated within the present system to identify managers who are underperforming in categories such as advisee motivation, activity monitoring, skill building, etc.—any metric measured as detailed in the forthcoming disclosure. Some organizations may only look to sales production in identifying which advisors and managers are doing well—however, this may overlook productive advisors and managers who simply need training to become more productive. Using the data generated within the present system, generative AI may identify these otherwise productive advisors and managers and facilitate improvement in their efficiency, skill sets, performance, and success.

Additionally, generative AI may facilitate changing the corporate culture. For example, the AI may identify the demographics and commonalities of the most successful advisors and managers. In some embodiments, this includes the AI identifying demographics that are associated with better and/or worse benchmark scores. This may then be used for recruiting advisors and managers who have the highest probability of success, and then providing them with the resources needed to continue being successful. Generative AI may also assist with identifying which advisors display the skills best suited to become managers. Generative AI may also assist with identifying which advisors and/or managers are likely to fail, so they can be “coached out” of the career sooner, thereby causing them to not stick around for longer and negatively impact the culture of the organization.

Generative AI, coupled with the system of the present disclosure, allows more consistent, adaptive, and scalable mentoring and coaching. This may include communicating in an effective and efficient manner by using natural language dialogue and/or customized videos based on the demographics of the advisor and manager, as well as the advisor's client base demographics. This may include finding and/or creating natural language dialogue or videos with training processes, motivational techniques, and tips and tricks for different skill sets (i.e., how to get referrals, schedule meetings when phoning, find opportunities, open cases, close business, etc.). Advisors and managers may also be able to ask generative AI to diagnose specific issues. By way of example, the demographic of the advisor may influence the dialog or choice of words or expressions used by an avatar created by the AI to provide the advisor with any messages.

Generative AI may further connect all facets of an advisor's or manager's activities (e.g., collection of metrics, as described herein) to make deeper connections, solve root cause problems, and recommend corrective actions or improve skill sets on these root cause problems rather than treating the specific metric that is not meeting its benchmark. By way of example, if an advisor is not succeeding in their production goals and cash flow needs, the AI may recognize that the advisor is not obtaining enough favorable introductions to make enough phone calls to schedule enough discovery meetings to close enough business to succeed in their production goals and cash flow needs. In this embodiment, the AI would suggest treating the problem through advising an increase in referrals to increase the number of favorable introductions and/or improving the advisors' skill sets with respect to obtaining referrals, rather than attempting to directly treat the problem of success in production goals and cash flow needs.

Generally, in addition to the previous disclosure, generative AI may be capable of interacting with any of the data generated and/or retrieved in the system of the present disclosure as detailed throughout this specification. Furthermore, generative AI may be capable of automatically detailing next actions based on any and all of this generated and/or retrieved data, including but not limited to correcting actions of advisors and managers when they are either currently or heading in the direction of being unsuccessful with regard to any of the herein mentioned metrics of success.

The modules, as described and detailed below, may be accessible through the use of a software application. AI may be incorporated to gather data with respect to the interaction between a user and the software application and form courses of action based on the gathered data to thereby improve or facilitate the improvement of relevant benchmark scores (i.e., ratios based upon the skills and/or performance and/or outcomes with respect to a predetermined benchmark) for the advisors, managers, or the organization as a whole.

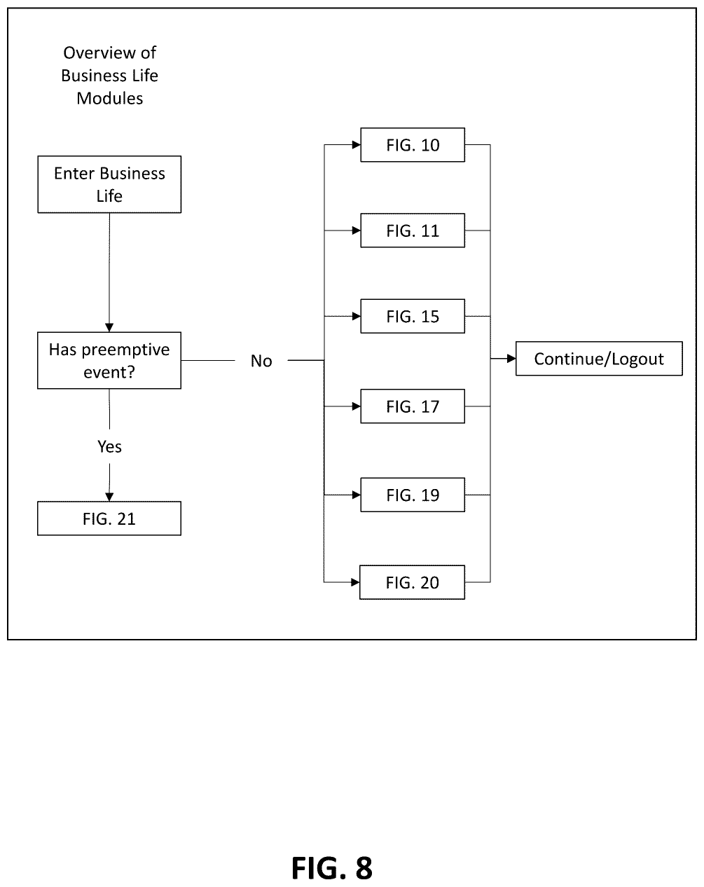

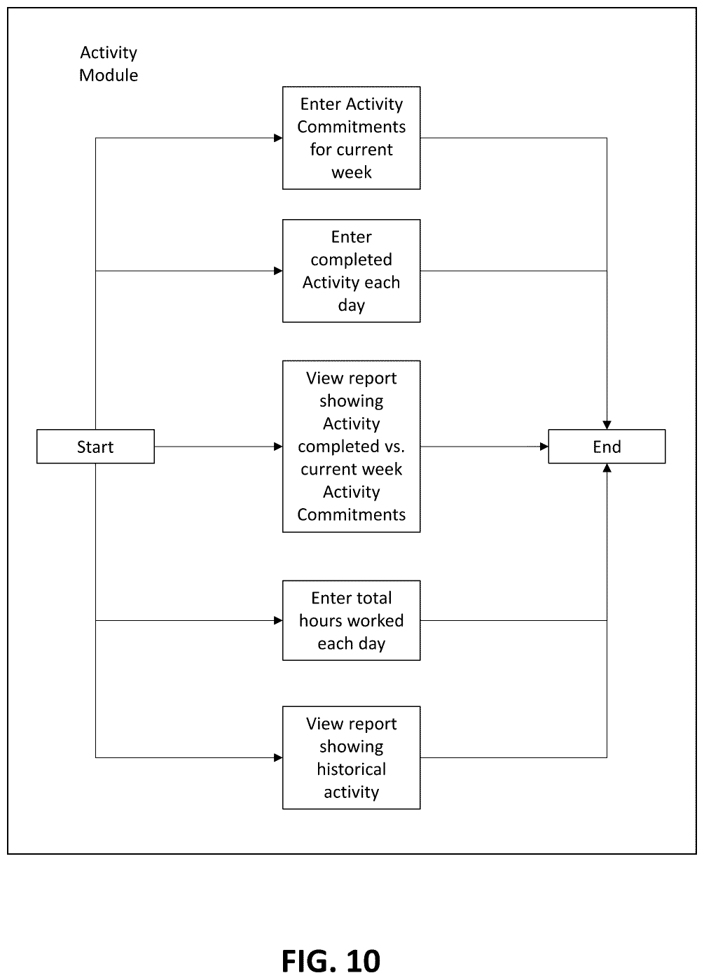

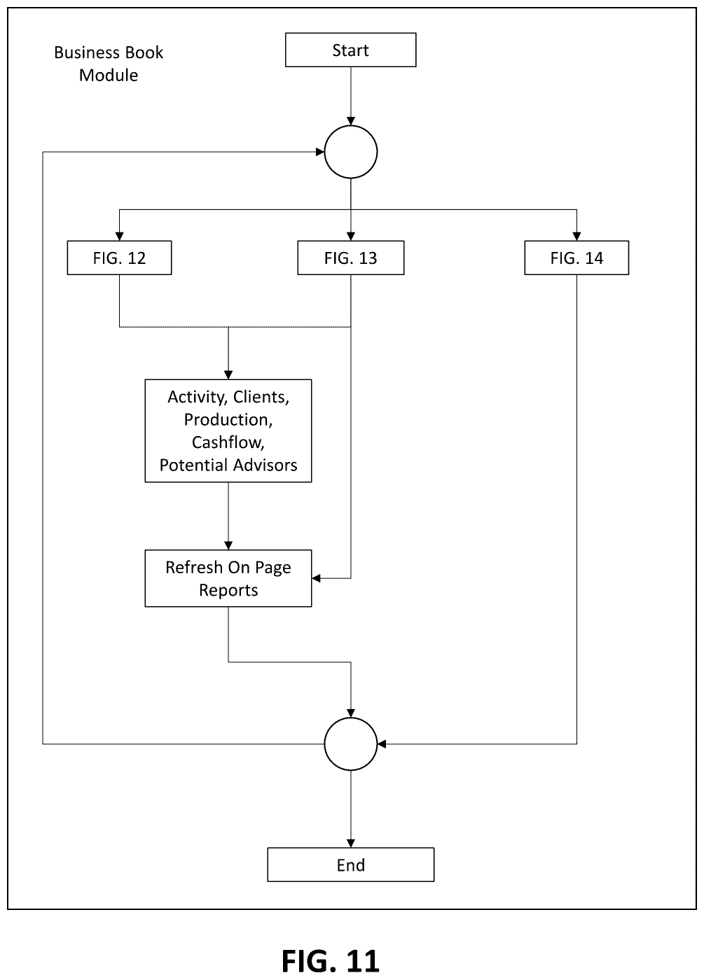

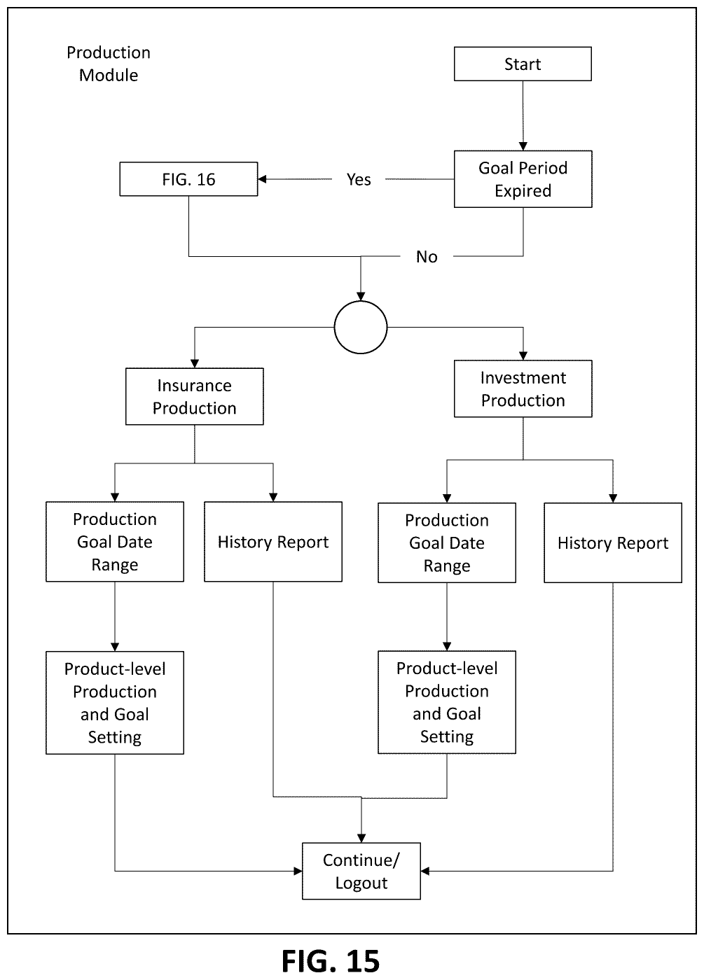

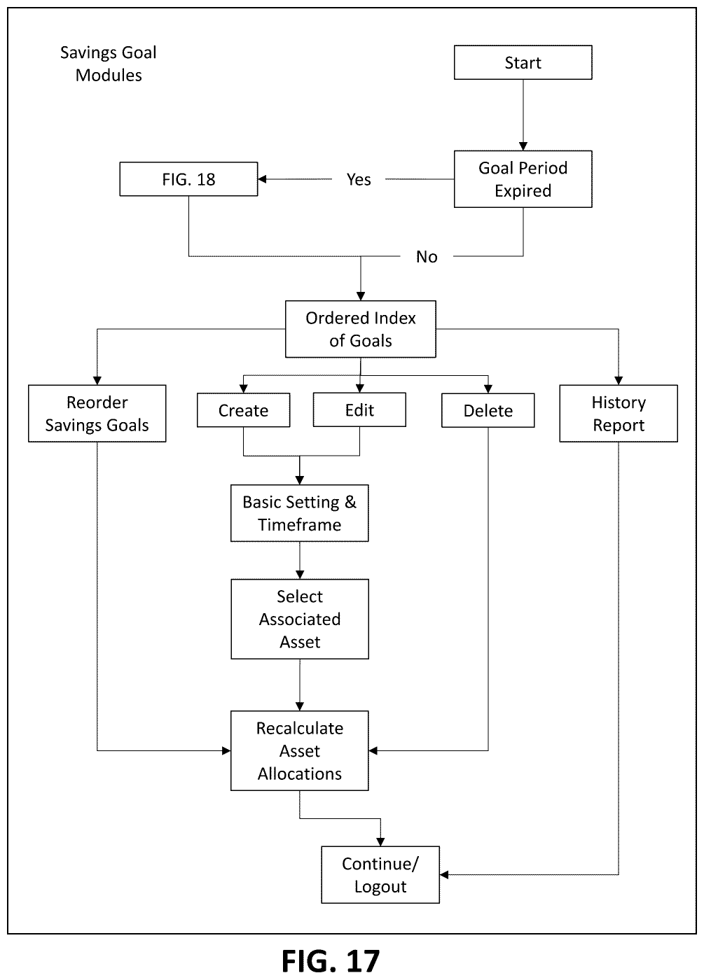

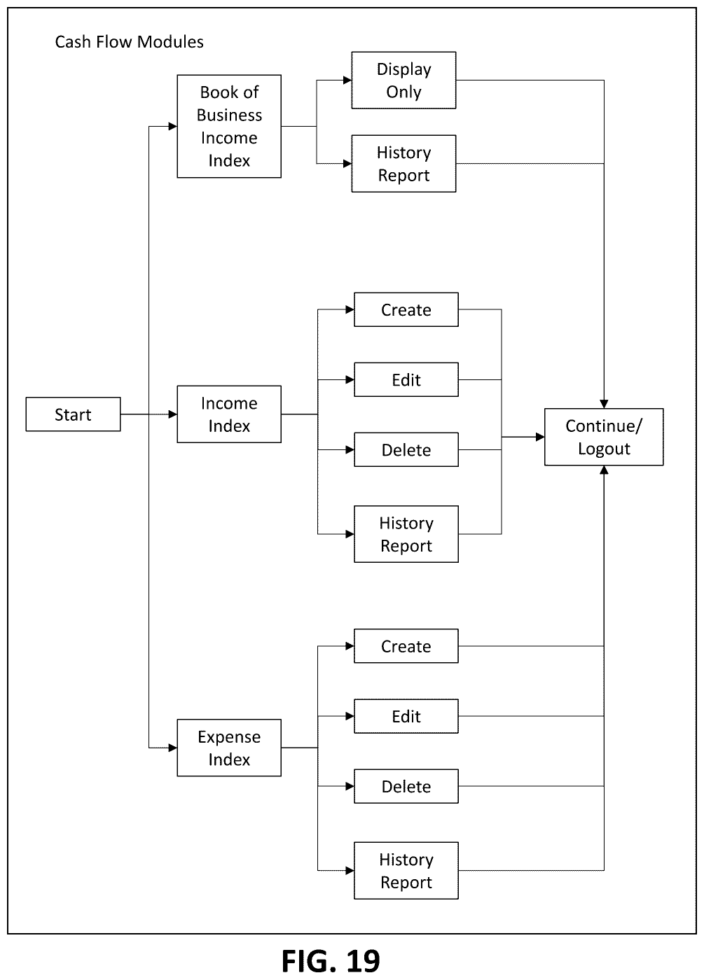

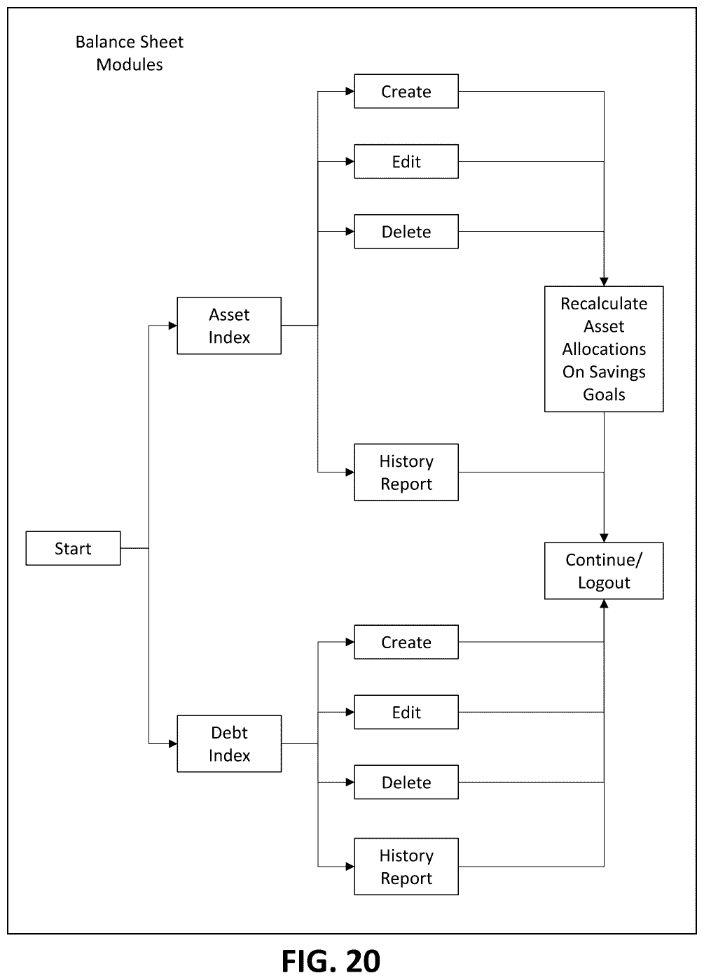

FIG. 8 illustrates a flowchart depicting an overview of business life modules, according to some embodiments. Generally, the business life modules contain all data entry and key success metrics reporting for the advisor's business (i.e., the book of clients the advisor is directly working with as a part of a larger organization). In general, the advisor may choose their activity module (as detailed and described further in FIG. 10), their business book module (as detailed and described further in FIG. 11), their production module (as detailed and described further in FIG. 15), their savings goal module (as detailed and described further in FIG. 17), their cash flow module (as detailed and described further in FIG. 19) and/or their balance sheet module (as detailed and described further in FIG. 20).

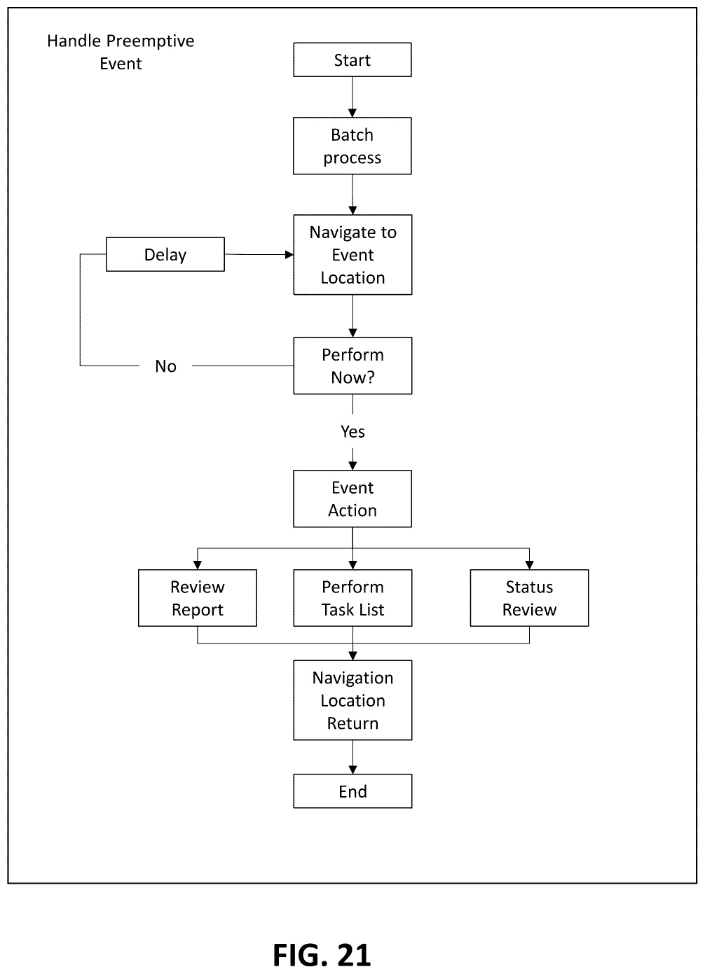

Upon entry into business life modules, a preemptive event may occur based on the advisor's performance or status. If such an event occurs, the advisor may choose to either handle the event at that time or delay the event to a later time (as detailed and described further in FIG. 21).

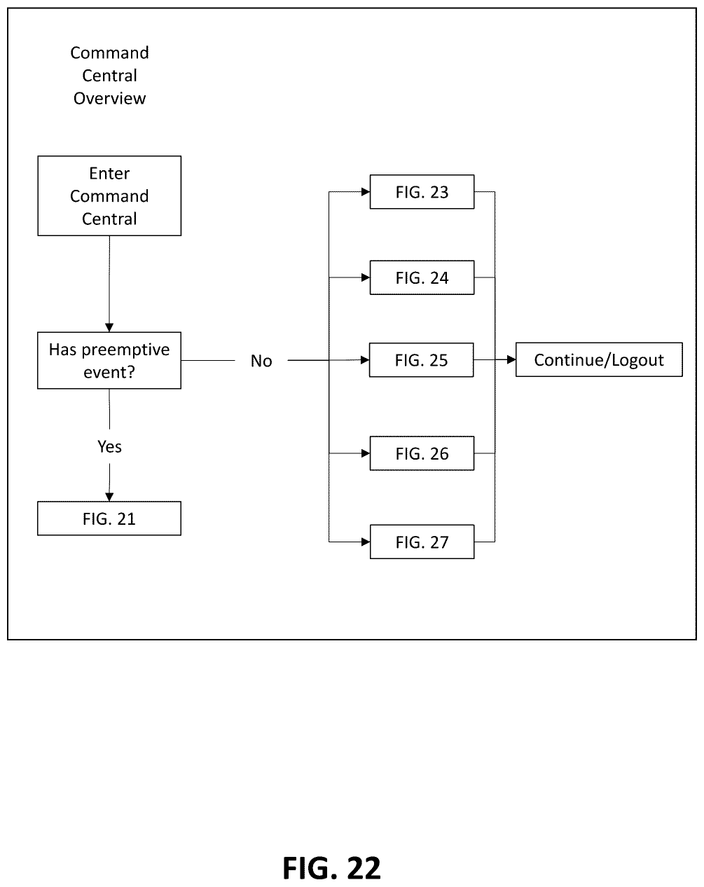

The information garnered from the business life modules may be combined with that in the command central modules (as detailed and described further in FIG. 22) in order to present a full view of the user's financial health and long-term likelihood of success.

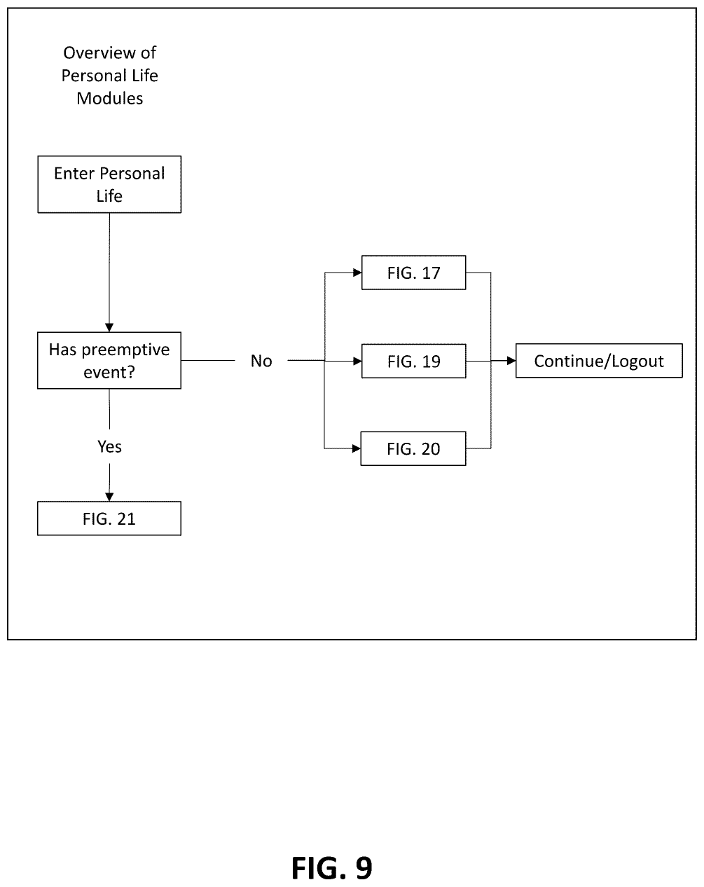

FIG. 9 illustrates a flowchart depicting an overview of personal life modules, according to some embodiments. Generally, the personal life modules display advisors' personal financial health and its relationship with their business. As seen in FIG. 9, many of the modules presented in the business life modules of FIG. 8 may also be present in the personal life modules. Advisors may choose their savings goal module (as detailed and described further in FIG. 17), their cash flow module (as detailed and described further in FIG. 19), and/or their balance sheet module (as detailed and described further in FIG. 20).

Similar to business life, preemptive events may occur and are either completed in real-time or delayed to a later time.

FIG. 10 illustrates a flowchart depicting an activity module, according to some embodiments. This module details the different activities that may take place in a user's business life. For example, the user may enter activity commitments for the current week. The user may also enter completed activities for each day. In some embodiments, the user may view a report showing activities completed with respect to their activity commitments for a given week. The user may be instructed to enter the total number of hours worked each day. The present disclosure may calculate total hours worked versus revenue-generating hours worked, which is key data advisors use to make the decision of when to hire an employee(s). According to some embodiments, the user may view a report showing a history of their activity. When paired with AI, the software of the present disclosure may be able to tell advisors when they are spending too much time performing non-revenue-generating activities based on the optimal ratio of revenue-generating hours worked versus total hours worked. Over time, the software may be able to find the revenue-generating hours worked versus the total hours worked ratio for advisors at various performance levels, and for advisors having various metrics and demographic information.

Stated another way, the activity module may request advisors to enter their revenue-generating activities. In some embodiments, the activity module provides advisors' performance with respect to activity commitments versus actual activity for a set period of time. The activity module may further provide a graph of past activities. According to some embodiments, the activity module shows advisors the income earned per revenue-generating activity.

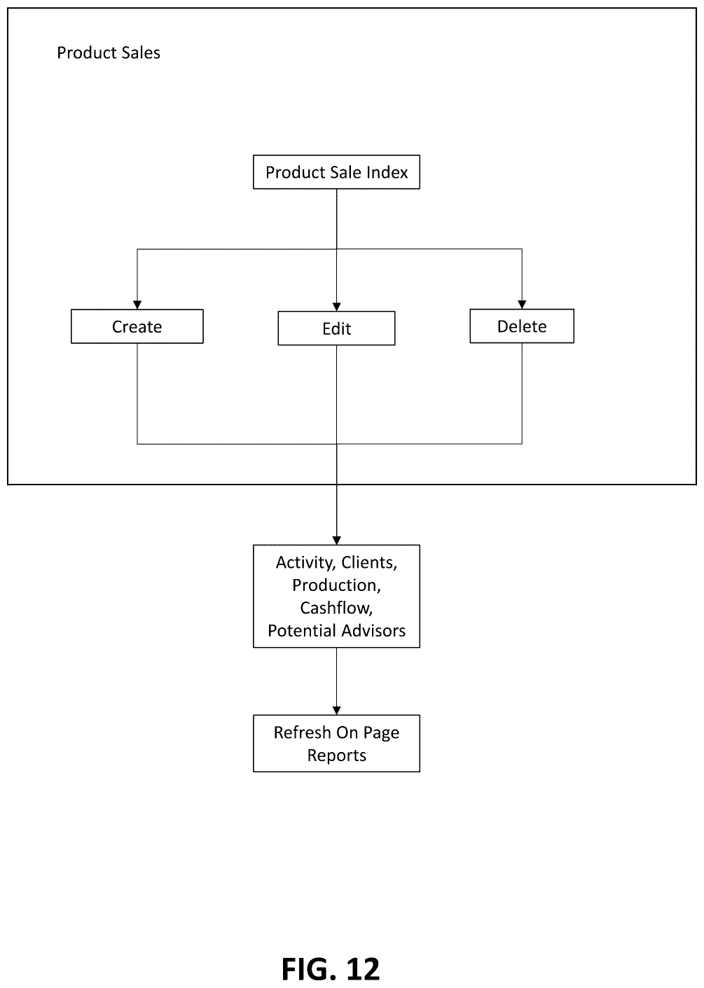

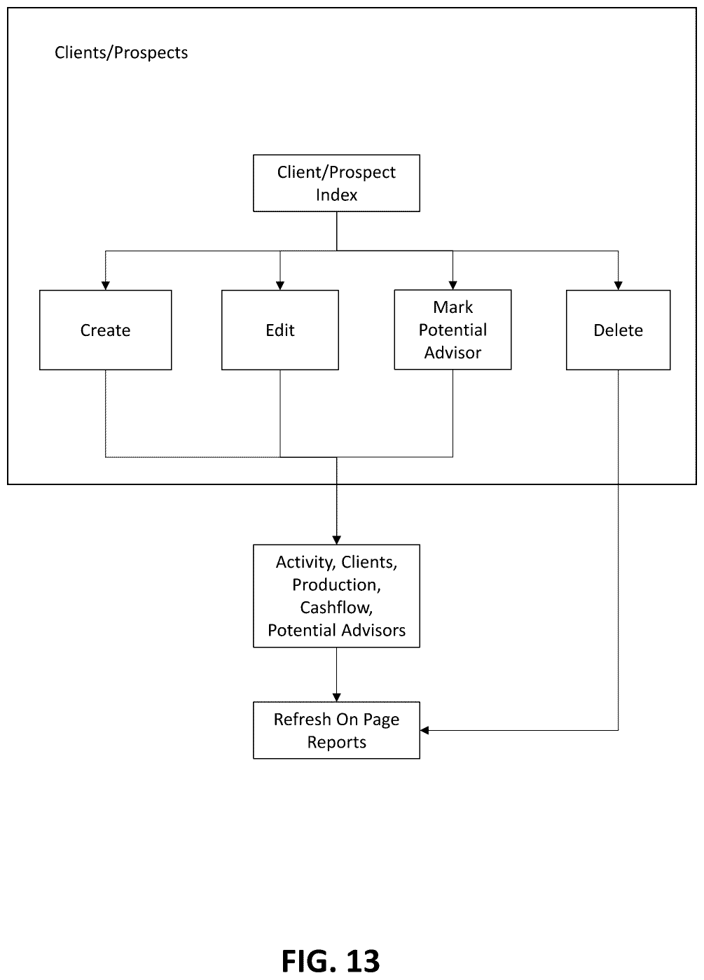

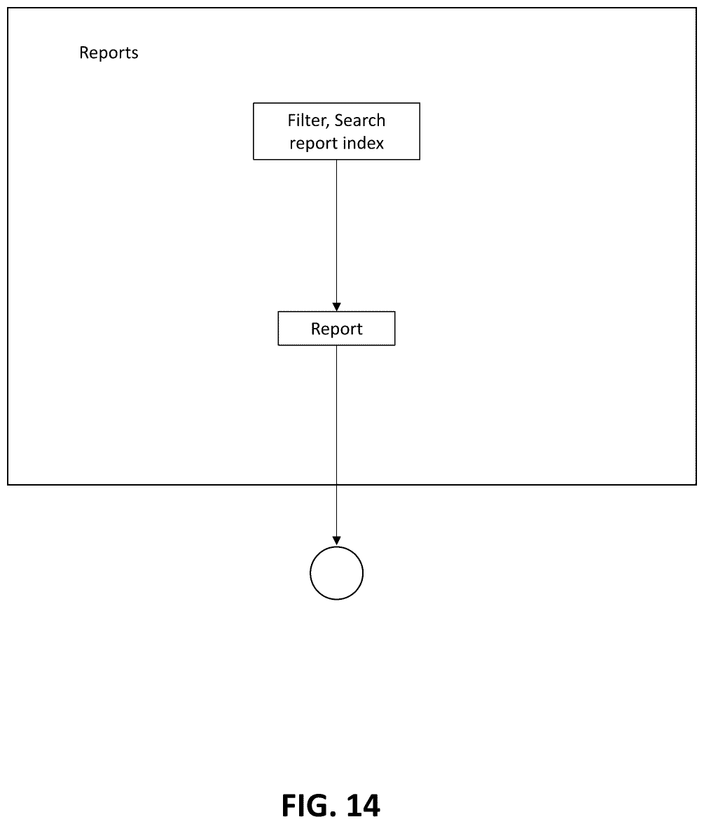

FIG. 11 illustrates a flowchart depicting a business book module, according to some embodiments. This module details the different portions of a business book that may be generated and interacted with by a user, including product sales (as detailed and described further in FIG. 12), clients/prospects (as detailed and described further in FIG. 13), and reports (as detailed and described further in FIG. 14).

Generally, activity is related to product sales, clients, production, cash flow, and potential advisors. Additionally, the activity, clients, production, cash flow, and potential advisors will lead to refreshing the on-page reports. From refreshing the on-page reports or the reports module specifically, the user may end the process of the business book module or begin again from the start. For an in-depth description of the sales cycle process, see FIGS. 1-7 above.

FIG. 12 illustrates a flowchart depicting a product sales module, according to some embodiments. This module begins with a product sale index. From here, the user may create, edit, or delete entries; the sales entries use and/or impact records from the activity, clients, production, cash flow, and potential advisors list. After this, any affected on-page reports may be automatically refreshed.

FIG. 13 illustrates a flowchart depicting a clients/prospects module, according to some embodiments. This module begins with a client/prospect index. From here, the user may create a client/prospect entity, edit the client/prospect entity, or mark the client/prospect entity as a potential advisor (i.e., a good fit for a career in the financial services industry). Changes in the client/prospect entities are related to activity, clients, production, cash flow, and potential advisors. After this point, they may refresh the on-page reports. The user may also delete from the client/prospect index, which also causes a refresh of the on-page reports.

FIG. 14 illustrates a flowchart depicting a reports module, according to some embodiments. This module begins with filtering and searching the report index. This permits the user to find a report. This report may then be generated in a form such as a .html or .xlxs document.

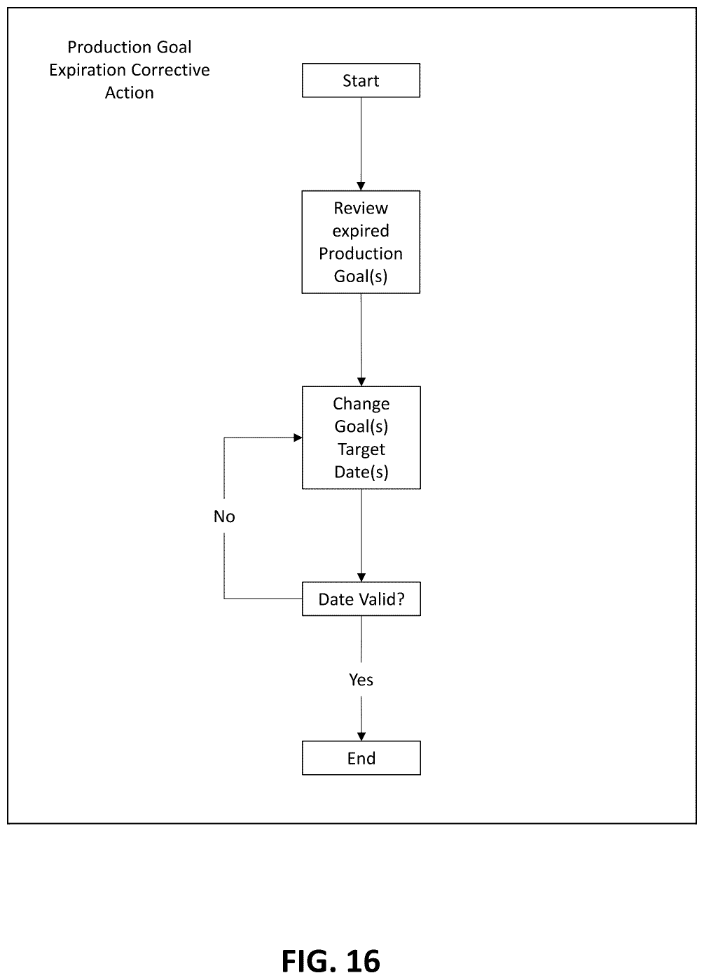

FIG. 15 illustrates a flowchart depicting a production module, according to some embodiments. This module begins by querying if a goal period has expired. If the answer is yes, corrective action is taken. This production goal expiration corrective action is detailed and described further in FIG. 16. In some embodiments, production goal periods must remain current in order to ensure activity recommendations and projected calculations in the command central modules remain relevant.

If the goal period has not expired, the user may choose between insurance production and investment production. Generally, insurance production is broken into different forms of insurance, such as life, disability, or long-term care, to name a few examples. Investment production may be broken up into different forms of investment, such as brokerage or advisory.

In either case, the user may retrieve the production goal date range and then set product-level production goal settings. Product-specific goals for insurance may include policies, new clients, premiums, and commissions, to name a few. Product-specific goals for investment may include assets under management (AUM), commission, and monthly fees, as some examples. According to some embodiments, goal values are read and derived from the book of business.

Also, in either case, the user may generate and view a history report. After viewing the history report or setting product-level production goals, the user may continue to the business life modules of FIG. 8 or log out of the system.

FIG. 16 illustrates a flowchart depicting a production goal expiration corrective action process, according to some embodiments. If the goal has expired in the production module of FIG. 15, the user may be prompted to review their expired production goal(s). The production goal periods may be separated between insurance goal periods and investment goal periods.

Once the user has reviewed the expired production goal(s), they may be prompted to change the target date(s) for such production goal(s). If the date is invalid, they may be prompted to change the target date(s) for such production goal(s) once again. If the date is valid, they have completed the production goal expiration corrective action process and may return to the production module.

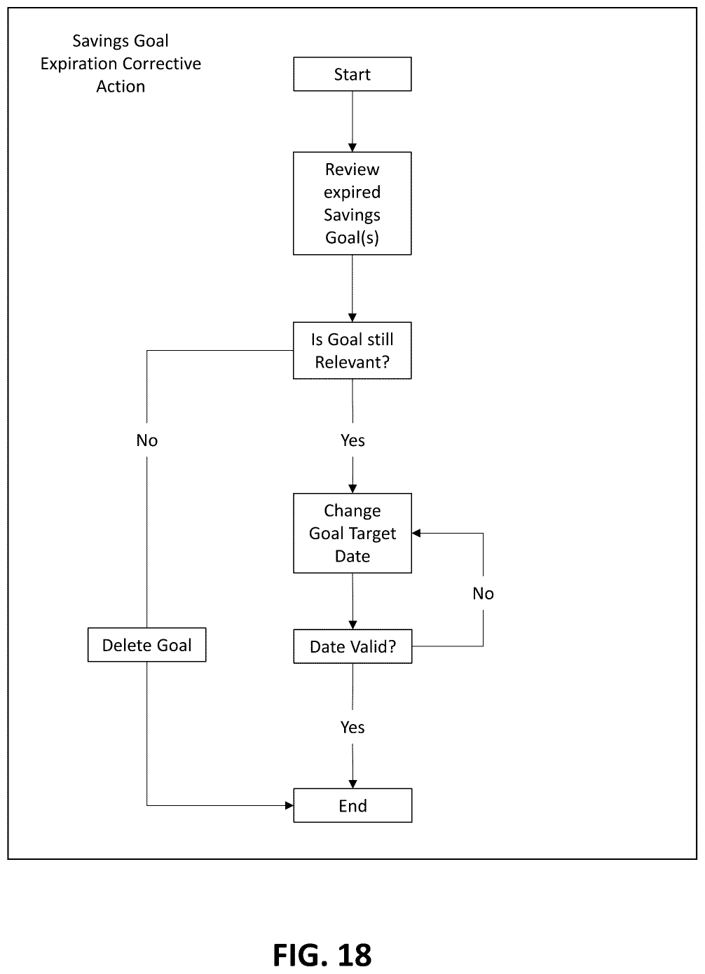

FIG. 17 illustrates a flowchart depicting a savings goal module, according to some embodiments. This module is similar for each of the business life modules of FIG. 8 and the personal life modules of FIG. 9, varying slightly based on the differences in types of goals in a user's business and personal life. This module begins by querying if a goal period has expired. If the answer is yes, corrective action may be taken. This savings goal expiration corrective action is detailed and described further in FIG. 18. In some embodiments, savings goal periods must remain current in order to ensure activity recommendations and projected calculations in the command central modules remain relevant.

If the goal period has not expired, the user may retrieve an ordered index of goals. This order of saving goals may determine the priority of the goals and how the assets chosen will be distributed between these goals. From this ordered index of goals, the user may create and/or edit basic settings and timeframe(s). From here, they may select the associated assets. In some embodiments, associated assets are selected based on whether the user has come from the business life modules or the personal life modules. I.e., business savings goals may focus on business assets, while personal savings goals may focus on personal assets.

From the ordered index of goals, the user may also delete goals or reorder their savings goals. From either of these or from selecting the associated assets above, the system may recalculate allocations of the assets. The user may also generate or retrieve a history report from the ordered index of goals. From either the history report or the recalculation of allocations of the assets, the user may continue to the business life modules of FIG. 8, the personal life modules of FIG. 9, or log out of the system

FIG. 18 illustrates a flowchart depicting a savings goal expiration corrective action process, according to some embodiments. If the goal has expired in the savings goal module of FIG. 17, the user may be prompted to review their expired savings goal(s). This savings goal expiration process may apply equally to both business and personal savings goals.

Once the user has reviewed their expired savings goals, they may be prompted to review whether the goal is still relevant. If the goal is no longer relevant, the goal is deleted, and the user has completed the savings goal expiration corrective action process and may return to the savings goal module. If the goal is still relevant, the user may then adjust the goal's target date.

Once a user has entered a new target date for the goal(s), if the date is invalid, the user may be prompted to enter a new target date once again. If the date is valid, the user may have completed the savings goal expiration corrective action process and then return to the savings goal module. The software of the present disclosure may be coupled with a projecting software, further allowing the software to run analyses such as retirement analysis, education funding analysis, other savings goal analysis, and/or net worth projection.

FIG. 19 illustrates a flowchart depicting a cash flow module, according to some embodiments. Once again, this module is similar for each of the business life modules of FIG. 8 and the personal life modules of FIG. 9. From the cash flow module start, a user may review the book of business income index (this may only come from the business life module, as it may not be impacted by the user's personal life). This may be only a display of this index, or a generated or retrieved history report. The display for the book of business income may be automatically calculated and/or updated based on the book of business. The software may be linked to an advisor's customer relationship management (CRM) where their book of business income is automatically pulled in. In addition to pulling in the book of business income, the software may be able to pull in households from CRM. Households may lead to favorable introductions, sales opportunities, closed business, and active clients. In some embodiments, this is finalized on a monthly basis. According to some embodiments, when the software is linked to the advisors' CRM, this is updated daily. From here the user may continue back to the business life modules or log out of the system.

Also from the cash flow module start, a user may review the income index. From here, the user may create, edit, or delete items from the income index, as well as generate or retrieve a history report. The income records display may include a name/description, balance/amount, and reoccurring toggle. This may also be linked to a time frame, such as a specific month. After any of these actions are taken, on-page reports are automatically refreshed, and the user may continue back to the business life modules, the personal life modules, or log out of the system.

Finally, from the cash flow module start, a user may review the expense index. The actions and items within the expense index are similar to those of the income index above but will be reiterated here. The user may create, edit, or delete items from the expense index, as well as generate or retrieve a history report. The expense records display may include a name/description, balance/amount, and reoccurring toggle. This may also be linked to a time frame, such as a specific month. After any of these actions are taken, on-page reports are automatically refreshed, and the user may continue back to the business life modules and the personal life modules or log out of the system.

FIG. 20 illustrates a flowchart depicting a balance sheet module, according to some embodiments. This module is also similar for each of the business life modules of FIG. 8 and the personal life modules of FIG. 9. From the balance sheet module start, a user may review the asset index. From here, a user may create, edit, or delete items from the asset index. Once one of these actions has been taken, the asset allocations on saving goals may be recalculated. Associated assets may be selected based on the page type. For example, business savings goals focus on business assets, while personal savings goals focus on personal assets. After any of these actions are taken, relevant on-page reports are automatically updated. The software may prompt the user to update the income, expense, and balance sheets at predetermined and/or recurring time periods (e.g., every Monday, the beginning of the month, five days before the end of the month, etc.). In addition to prompting the user to make updates, other prompts may be provided by the software. Over time, as the software and AI learn about what prompts are needed by the user, the AI may identify prompts that are not needed and stop sending them.

The user may also generate or retrieve a history report for the asset index. After this or the recalculation of asset allocations on savings goals, the user may continue back to the business life modules, the personal life modules, or log out of the system.

From the balance sheet module start, a user may also review the debt index. From here, a user may create, edit, or delete items from the debt index. After any of these actions are taken, relevant on-page reports are automatically updated. The user may also generate or retrieve a history report for the debt index. After any of these actions are taken, the user may continue back to the business life modules, the personal life modules, or log out of the system.

FIG. 21 illustrates a flowchart depicting a handle preemptive event process, according to some embodiments. If, in the business life modules of FIG. 8, the personal life modules of FIG. 9, or the command central modules of FIG. 22, a preemptive event exists, the user may be brought to a module to handle this preemptive event. In some cases, preemptive events are disruptive to the normal workflow in the system. The goal of this process may be to refocus the attention of the advisor on various areas within this system. Such a review may be set to a specific time frame or reference time, such as the start or end of the week, and/or the start or end of the month.

Batch processing is performed at the beginning, and events may be run on a fixed frequency (i.e., weekly, monthly, quarterly, annually, etc.). A user may then be navigated to an event location. In some embodiments, each event has a specific page or tab that the user is brought to. The user may be asked if the event should be performed immediately. If a user would not like the event to be performed immediately, they may delay the action for a period of time.

If a user would like the event to be performed immediately, the event will then occur. The event may provide structure and motivation for the advisor to enter required information, prepare for the future, and/or stay informed on current statuses within the system. Events may occur to provide the user with recommendations on what actions need to be taken in order to succeed in goals and in building a business.

As part of the event, the user may review the report on the action, perform a task list generated by the action, or review the status of the event. After any of these actions are taken by the user, they may be navigated to their previous location—in this embodiment, to either the business life modules of FIG. 8 or the personal life modules of FIG. 9.

FIG. 22 illustrates a flowchart depicting a command central overview module, according to some embodiments. Generally, the command central modules present data on key performance measures and metrics, facilitating quick assessment of an advisor's strengths and weaknesses. These performance metrics may include historical, current, and projected financial details for an advisor's business and personal life. In some embodiments, the performance metrics include current and projected business production relative to goals and various activity levels. The performance metrics may permit the system to provide recommendations for an advisor's business activities so that they accomplish their sales goals, such as new client goals and policy sales goals. The performance metrics may also permit the system to provide recommendations for an advisor's business activities so that they generate enough business revenue to fulfill their personal and professional income needs as well as their personal and professional savings goals and/or major purchase goals.

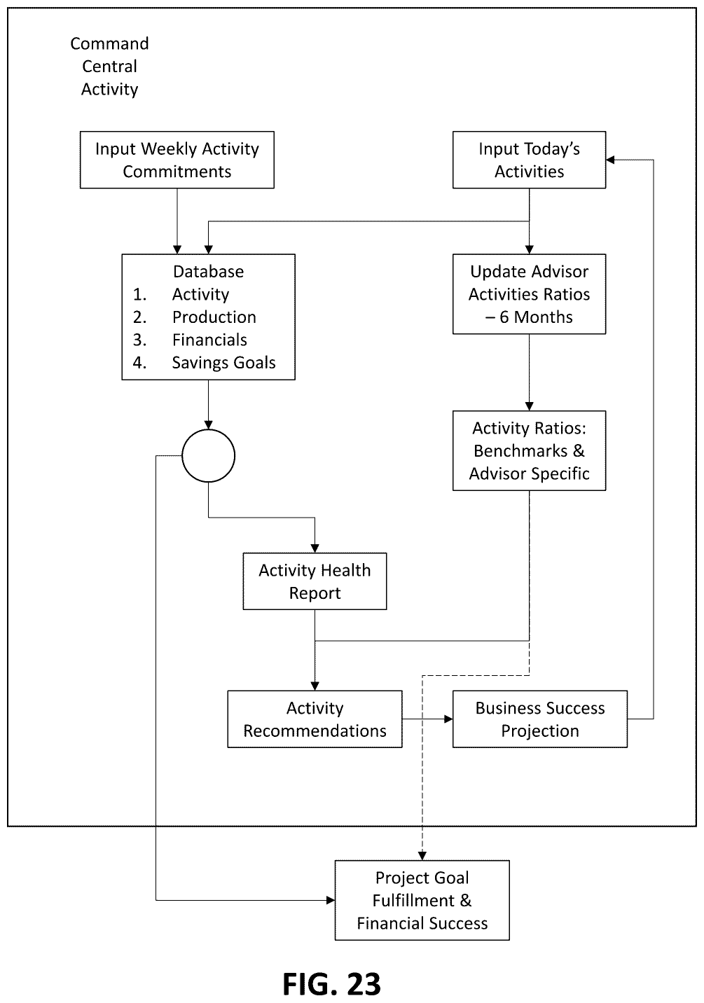

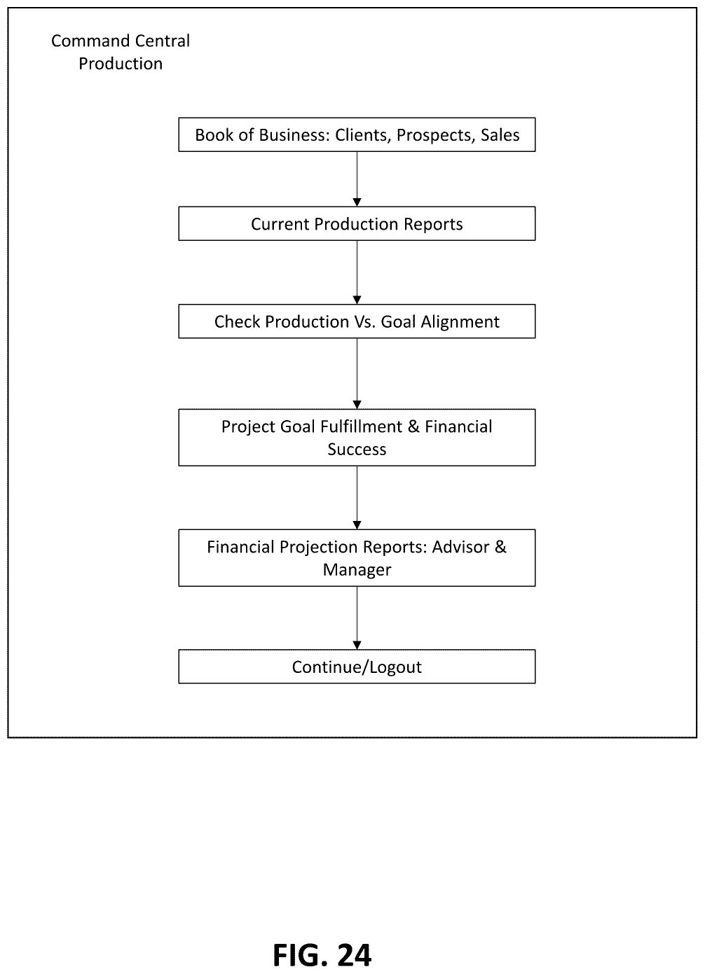

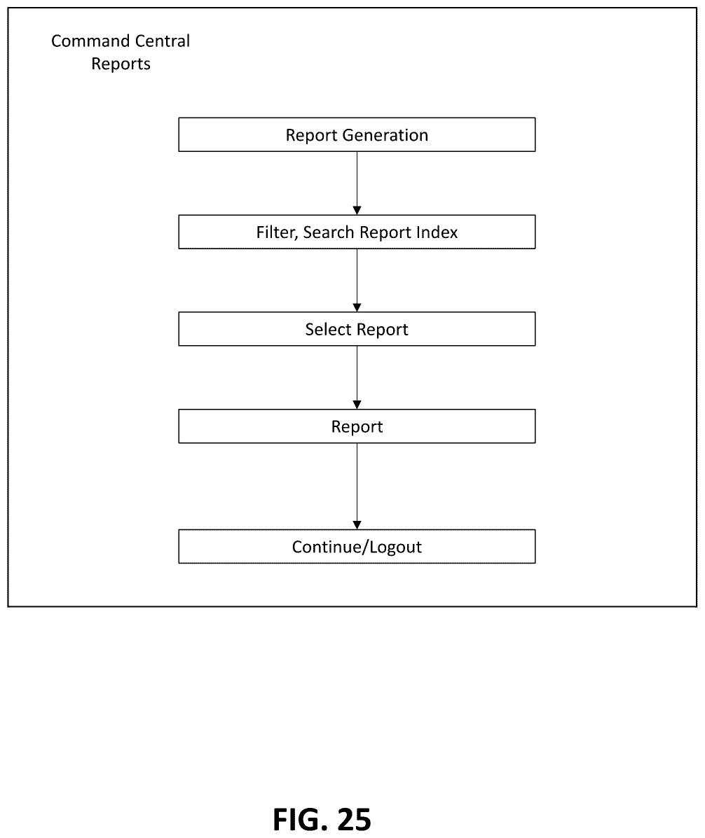

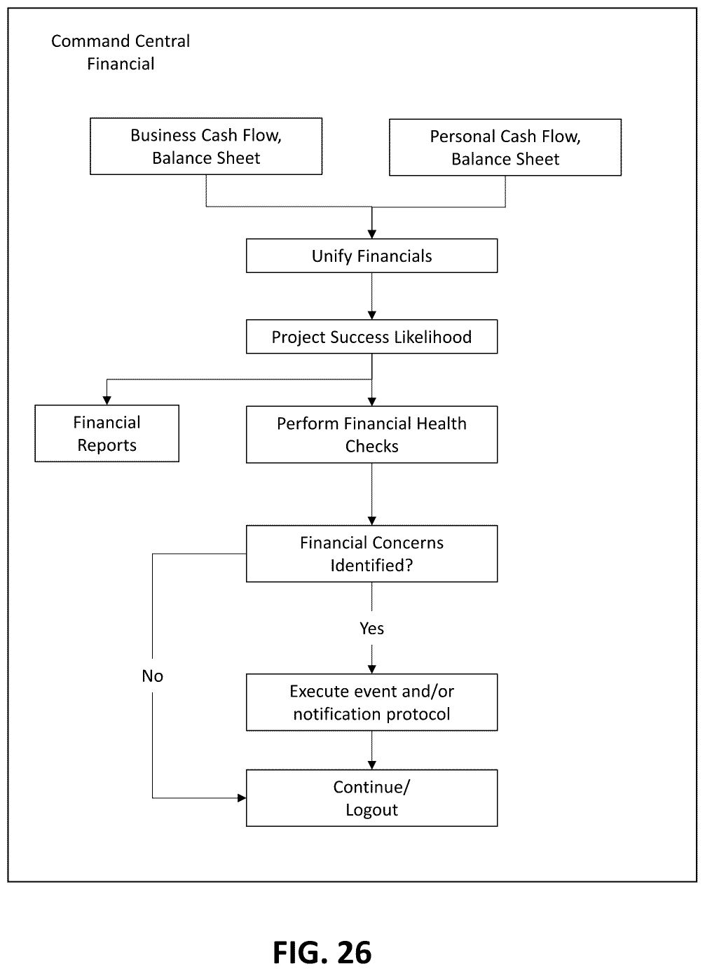

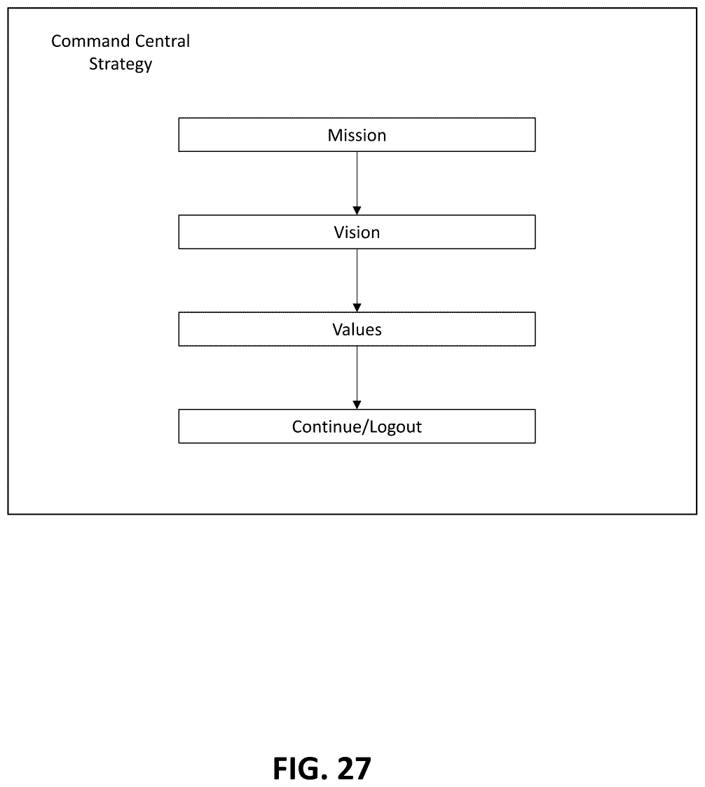

In the command central module, advisors may choose to view the command central activity module (as detailed and described further in FIG. 23), the command central production module (as detailed and described further in FIG. 24), their command central reports module (as detailed and described further in FIG. 25), the command central financial module (as detailed and described further in FIG. 26), and/or the command central strategy module (as detailed and described further in FIG. 27). If there is a preemptive event, one may continue on to handle the preemptive event (as was detailed and described further in FIG. 21).

By way of example, the command central modules may summarize data garnered from other modules within the system, providing a high-level view of key performance and financial metrics, in addition to goals, status toward goals, projected outcomes, and mission statements, vision statements, and value statements.

These data may include, but are not limited to, current and historical cash flow details, as well as the income advisors/users need to generate in order to achieve a positive cash flow, personally and professionally, and accomplish personal and business savings goals, and/or major purchase goals. Financial needs and recommendations throughout the system may be based on a 360-degree view of both the business and personal data of the advisor. The data may also include recommended targets for each business activity for a set time frame-such as for every day, week, and month. Such recommendations may focus on aligning the advisor's/user's activities with their sales goals, financial needs, and financial goals. The data may further include projected sales production and/or revenue based on a continuation of current and historical activities (e.g., prospect calls, prospects scheduled, discovery meetings, etc.) of the advisor. In some embodiments, the data includes projected closed business resulting from existing sales opportunities. In some embodiments, the data includes a completion percentage of the activity that is required to accomplish sales goals and personal and professional revenue needs and goals, based on historical advisor performance as well as benchmarks. Advisors/users may be instructed to enter activity commitments for set time frames in the command central modules based on these data points.

The command central modules may also include insurance information and data. This may include charts or graphs showing past sales production, as well as business activity recommendations in set time intervals to facilitate achieving insurance policy and new client sales goals. Similarly, the command central modules may include investment information and data, such as charts or graphs on investment assets under management, along with investment goals. Additionally, the command central modules may include charts and graphs depicting the historical, current, and projected cash flow, net worth, and liquid assets of the user.

FIG. 23 illustrates a flowchart depicting a command central activity module and the functionality of the command central activity processes, according to some embodiments. Within these processes, an advisor/user may be instructed to review activity recommendations, which are based on benchmark scores and/or ratios specific to the advisor's historical performance. Benchmark scores may be based on the advisor's service year and other demographics (e.g., race, gender, marital and family status, etc.), whereas advisor-specific ratios may be based on the historical performance of the user, which is based on a historical time period, such as six months. These ratios may also be used to measure projected sales goals fulfillment, financial success, and what skills the advisor/user needs to improve.

Stated another way, the system generates a projection of the advisor's sales goals and revenue production, based on the user's current activity commitments and historical activity. The purpose of such a projection may be to provide the user with an understanding of their projected performance. Using these activity recommendations and projections as a guide, the advisor will input their weekly activity commitments for each revenue-generating activity. The user may also input completed activities for the current day in the activity database. The software may automatically pull in the advisor's completed activity levels after a predetermined period of time, such as daily, from a CRM or activity tracking software.

By way of example, recommendations may be based on a future performance calculation based upon an advisor's performance ratio and/or based on an advisor's activity ratios. In some embodiments, for the first six months of an advisor's career, this performance ratio and/or activity ratio is set at a benchmark, and then after this time frame, this ratio becomes based upon the actual performance of the advisor. Benchmark scores may be modifiable by the advisor's manager.

The benchmark scores may also be automatically adjusted in real-time based on data associated with the advisor and associated upward or downward trends in the benchmark scores. For example, AI may automatically detect a change in trends associated with a benchmark score or benchmark scores, and provide a course of action with respect to data gathered from the advisor to “course correct” the trends for the respective benchmark score(s). By way of another example, the AI may automatically change a benchmark associated with the benchmark score in real-time, thereby automatically adjusting the associated benchmark score.

Stated another way, in some embodiments, the user's historical business activity and activity ratios are compared to benchmarks, as well as the activities to which the user has committed so that both the user and their managers can track data related to this business activity. This data may include business revenue, new clients, and insurance policies generated per business activity—all of which may be used to make recommendations within set time frames to ensure the user is on track for accomplishing their goals and financial needs. The data may also include trends of the advisor's activity as measured against their activity commitment in order to assess their ability to follow through with such commitments.

In some embodiments, the data includes the advisor/user's total hours worked as measured against their total revenue-generating hours worked. This may facilitate decision-making about where to best invest time and money—for example, hiring someone to take over the non-revenue producing work when it would be cost-effective to do so. This may include the use of an employee hiring calculator. In some embodiments, when an employee hiring calculator is paired with AI, the AI may be able to inform the advisor when it would be profitable to hire an employee. According to some embodiments, the data includes the average household income of prospective clients as ascertained from introductory meetings. There may be a direct correlation between such household income and a user's potential profitability. The data may also include a percentage of favorable introductions received from various sources, including but not limited to prospective clients, new clients, current clients, center of influences, and the advisor's natural market.

FIG. 24 illustrates a flowchart depicting command central insurance and investment modules, according to some embodiments. These modules may be based on the advisor's book of business, including clients, prospects, and sales. The advisor/user may generate or retrieve reports on their current and historical production. In some embodiments, the system may check an advisor's/user's production goals to verify they align with the user's personal and professional financial needs and savings goals and/or major purchase goals. The system may then create projections for the validity of fulfillment of the advisor's/user's goals and financial success.

These projections may be provided in the form of financial projection reports, for both the advisor and any manager of the advisor. After these reports are generated or retrieved, the user may be brought to a screen to continue (i.e., begin again from entering the command central modules or another module as described in this disclosure) or log out from the system as a whole.

FIG. 25 illustrates a flowchart depicting a command central reports module, according to some embodiments. According to some embodiments, this module begins with report generation. This may be a fixed set of time series reports on activity, sales, financials, savings goals, major purchase goals, or status produced on a periodic basis, such as weekly, monthly, quarterly, or yearly.

A user may then filter or search the report index before selecting a report. These reports may be provided in any matter of file type, including but not limited to .xlsx, .pdf, .html, etc. The user may then receive the report. After these reports are generated or retrieved, the user may be brought to a screen to continue (i.e., begin again from entering the command central modules or another module as described in this disclosure) or log out from the system as a whole.

FIG. 26 illustrates a flowchart depicting a command central financial module, according to some embodiments. This module may display a combined business and personal balance sheet, along with a combined view for both the advisor's business cash flow and personal cash flow. In some embodiments, the system then projects the likelihood of success in the user's goals and financial situation. This may occur through performing financial health checks, such as by way of generated or retrieved financial reports.

The system may then identify any financial concerns. If financial concerns are identified, the system may execute an event and/or a notification protocol. As above, these events or notifications may be based on the user's performance in comparison to the benchmark or their own historical performance. After this event and/or notification, or if there are no financial concerns identified, the user may be brought to a screen to continue (i.e., begin again from entering the command central modules or another module as described in this disclosure) or log out from the system as a whole. Additionally, AI may be able to more quickly identify when an advisor is trending toward a bad financial outcome.

FIG. 27 illustrates a flowchart depicting a command central strategy module, according to some embodiments. In such a module, the user may be brought to a mission statement, reiterating their goals. Next, the user may be brought to a vision statement, showing the user the prediction of their future success. Finally, the user may be brought to a values statement, reiterating what the user should prioritize. After this, the user may be brought to a screen to continue (i.e., begin again from entering the command central modules or another module as described in this disclosure) or log out from the system as a whole.

The graphs, charts, and data analytics found in the various command central modules as shown and described in FIGS. 22-27 are provided on various advising business activities and processes, including but not limited to phoning, introductory meetings, closing business, prospecting, and review meetings. The goal of these various analytics is to help focus the user's attention on effective activities to meet their production and revenue goals and/or needs. These metrics may be measured against the statistical benchmarks set in Al Granum's One Card System. In some embodiments, any time a user's ratios are below the benchmark in any of these categories, the manager will be notified so that they can improve the user's sales language and processes.

The present disclosure serves to improve on the existing art by not only providing comparisons of an advisor's ratios with, for example, the One Card system ratios, for only one time period, but by providing these ratios over various and disparate time periods (i.e., one-month, three-month, six-month, twelve-month, year-to-date, lifetime, etc.). Advisors may be prompted to review a monthly activity report at the beginning of each month that shows the advisors' monthly activity and key activity ratios. Through increasing the number and variety of time periods, trends can become evident, such as if an advisor is improving in a given area.

The methods, systems, and software of the present disclosure are further configured to improve on the existing art by not providing the same benchmarks for all advisors, regardless of any personal factors, but instead, through collecting data throughout many users' careers, benchmark scores can be curated to show what performance, activity levels, and/or activity ratios are appropriate benchmarks for users at different levels of sales production, specific to various demographics such as years of service, race, gender, marital and family status, among others. The present disclosure includes modifiable benchmarks based on the demographics of the advisor, such as how long they have been working as an advisor (i.e., years of service). Through collecting data throughout a user's career, the benchmark comparisons may be updated and better reflect the user's progress than a stagnant, one-size-fits-all benchmark. Additionally, finding demographic-specific benchmarks may allow managers and organizations to develop more pinpointed and targeted training and/or coaching strategies, specific to each advisor's demographics

The present system further improves on the existing art by not only automating calculations relating to the various metrics, demographic information, and ratios of any given user (as described herein), but also factoring the countless different permutations for each of these variables to arrive at an optimal course of action (as described herein). This includes using AI to optimize the course of action in real-time, based on continually received data, and where such optimization would be virtually impossible by any individual given the sheer magnitude of data and processing being performed in real-time. The optimization of the course of action may in turn help a user attain and/or exceed the benchmark for a given metric, or at least improve the respective benchmark score to reduce a deficiency gap between the respective data and benchmark for the metric.

Such optimization of the course of action may include calibrating the benchmark for a given user (e.g., advisor/manager/organization), which may include determining a tailored benchmark based on the demographic information associated with the user (e.g., based on their experience level, location of residence, etc.). Such calibration of the benchmark may help to at least partially level the playing field for the user when determining their benchmark scores and/or comparing the benchmark scores with other users.

Additionally, or alternatively, such optimization of the course of action may include determining an activity to adjust the data for a given metric, thereby potentially adjusting an associated benchmark score. Said activity may include, for example, a performance-related activity (e.g., seeking more prospective clients, etc.) and/or undergoing additional training to improve a skill set or multiple skill sets. Said determination of activity may be tailored based on the demographic information associated with the user.

Accordingly, the present disclosure may save the managers time, as well as generate more trust in the output comparison than a handmade calculation would. This also allows for taking the benchmark comparisons to an extreme, such as informing advisors how much of each business activity they must complete in order to accomplish sales goals and/or produce enough revenue to be financially successful based on the user's personal and professional financial needs and goals—something which is not currently done in this field.

Finally, the present disclosure also enables the provision of notifications to advisors and/or managers when critical issues need to be addressed. The managers may have the ability to determine which activity levels, performance conditions, and benchmarks trigger such a notification.

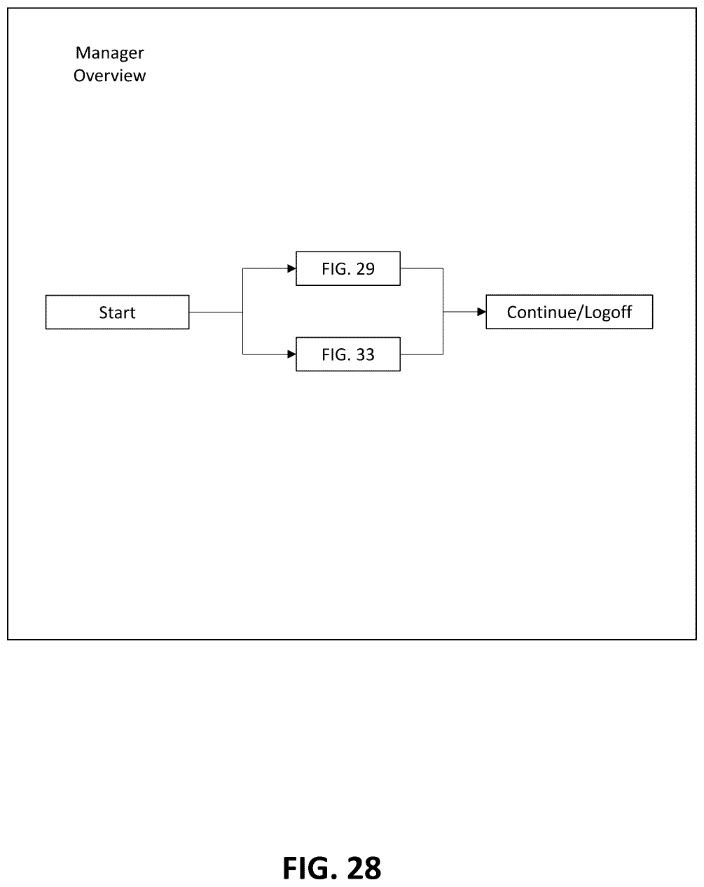

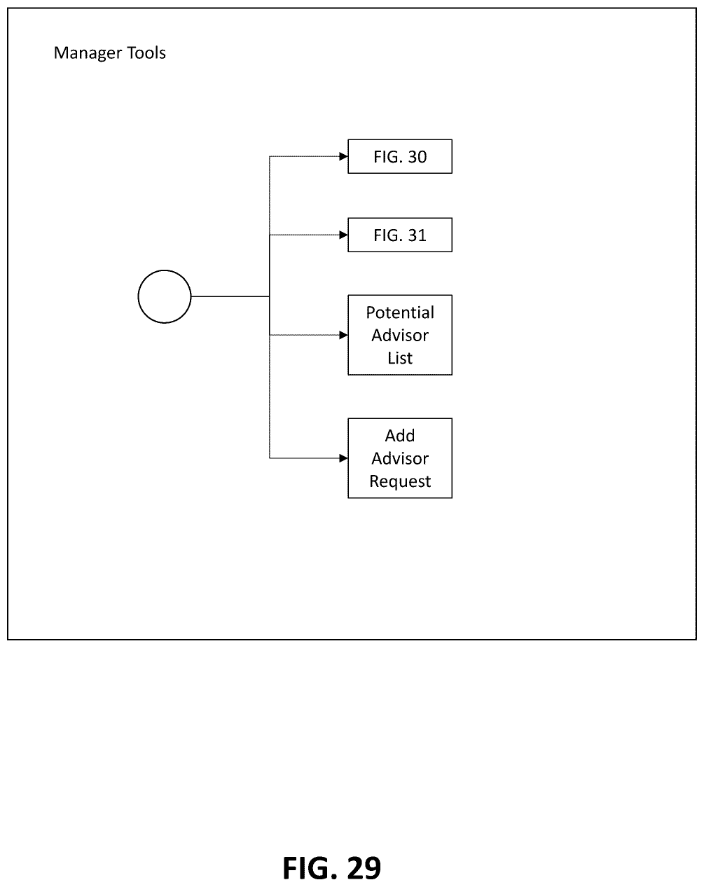

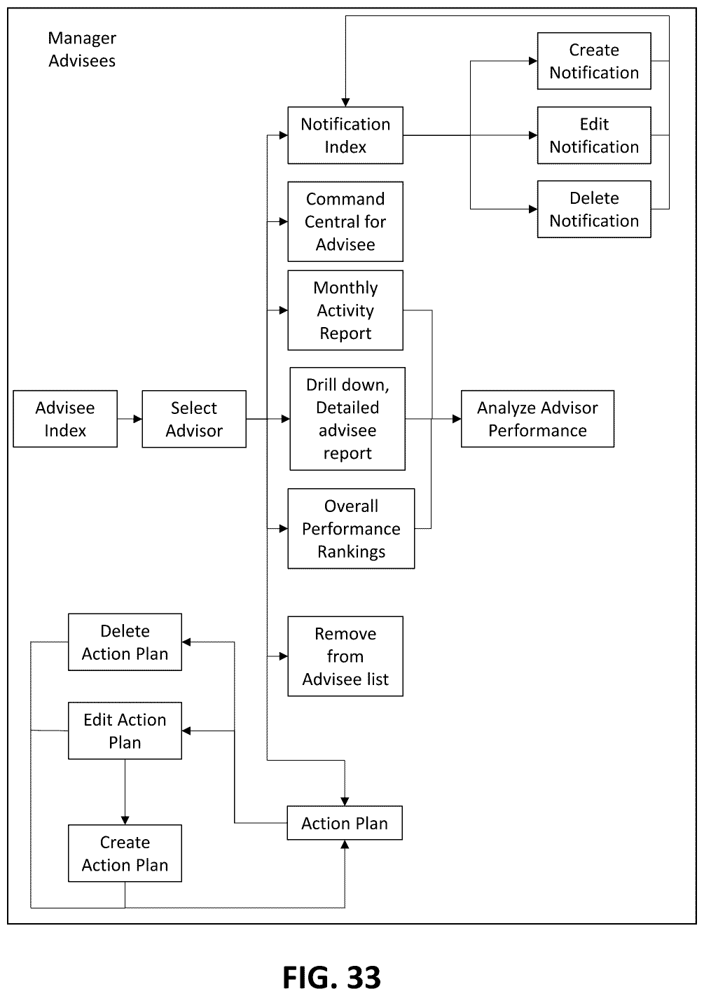

FIG. 28 illustrates a flowchart depicting a manager overview module, according to some embodiments. Generally, the manager overview module provides managers with objective data on the performance of the advisees reporting to them. This module may take the manager to a manager tools module (as detailed and described in FIG. 29), or a manager advisees module (as detailed and described in FIG. 33). From any of these sections, once completed, a manager may be brought to a screen to continue (i.e., begin again from entering the manager overview module or another module as described in this disclosure) or log out from the system as a whole.

In some embodiments, the manager overview module allows managers to customize activity recommendations that focus advisors on the activities necessary to succeed in their client market. According to some embodiments, the manager overview module provides managers with reports used for time-based coaching meetings and reviews, i.e., weekly coaching meetings and quarterly and annual reviews.

The manager overview module may provide the manager with a high-level overview of each advisee's activities and performance. These may include reports such as sales production, goals, projected performance reports, activity and activity commitments reports, and ratios and benchmark scores versus benchmarks reports which show the manager which areas each advisee needs to improve. Managers may also have the ability to dive further into each advisee's data through the modules pertaining to advisor performance above.

In some embodiments, the manager overview module notifies managers and/or their advisors when said advisors are underperforming. This may include selecting specific areas of focus for each individual advisor through setting notification qualifications. Some embodiments include an advisor not meeting a minimum number of calls in a week, not asking for a minimum number of referrals in a week, having a negative cash flow, having less than a minimum number of introduction meetings in a month, etc.

According to some embodiments, the manager overview module also provides managers with a tool to efficiently communicate with their advisees. This may include sending the advisors a notification when they fail to meet a specific benchmark, sending different forms of media, such as videos, articles, or emails, to different categories of advisors (such as different demographics, like new advisors versus experienced advisors) and sending a training module or other external application for the advisor to review.

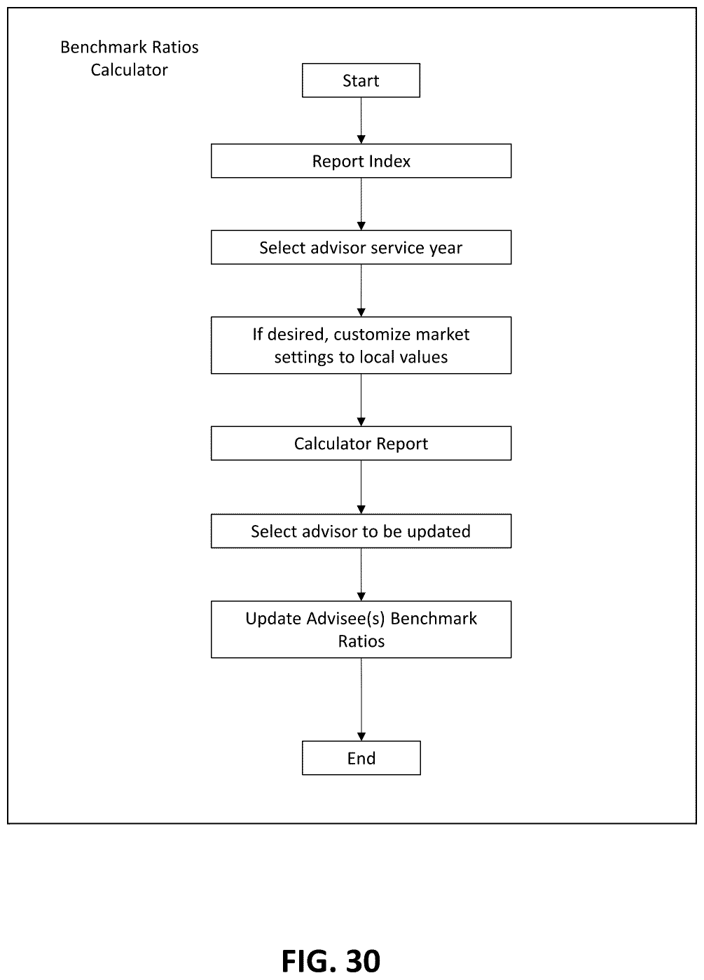

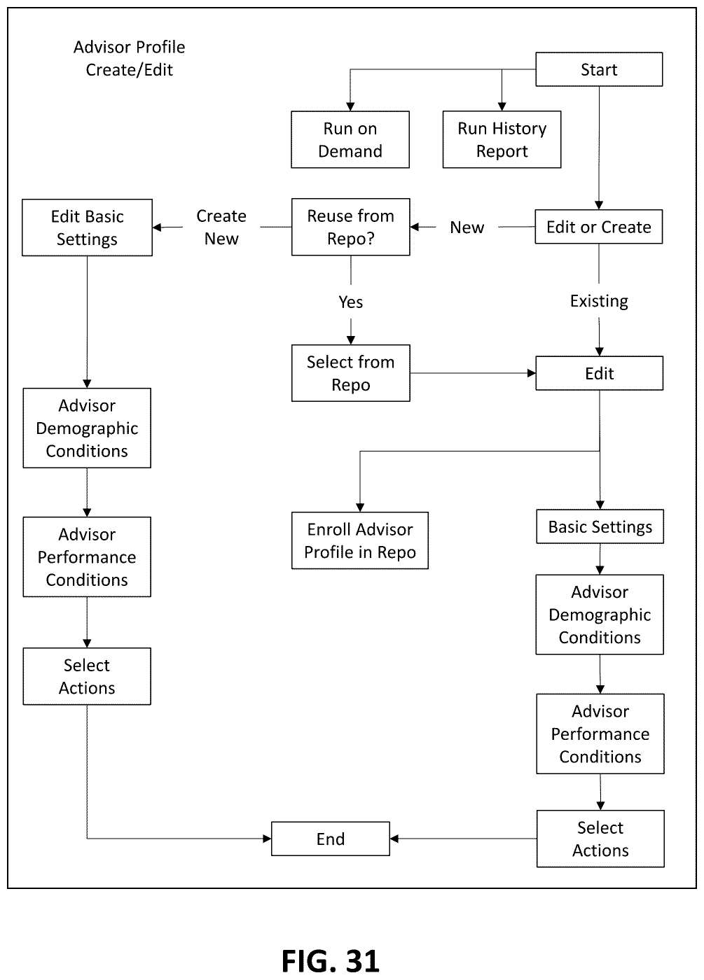

FIG. 29 illustrates a flowchart depicting a manager tools module, according to some embodiments. This module may permit a manager to retrieve a list of potential advisors or add an advisor request. In some embodiments, the module includes a benchmark scores calculator module (as detailed and described in FIG. 30). According to some embodiments, the module includes an Advisor Profile create/edit module (as detailed and described in FIG. 31).

FIG. 30 illustrates a flowchart depicting a benchmark scores calculator module, according to some embodiments. According to some embodiments, the module begins by taking the manager to a report index. In some embodiments, the module permits a manager to select the advisees' service year. If the manager desires, they can customize the market to local values. After this, the system generates a benchmark scores calculator report. The user may then select an advisee whose benchmark score(s) may need to be updated. At the manager's discretion, these results may be used as the benchmark(s) for selected advisees. This may occur through the manager selecting the advisee to be updated, and subsequently updating the advisee(s) benchmark scores.

The benchmark scores may also be automatically adjusted in real-time based on data associated with the advisor and/or associated upward or downward trends in the benchmark scores. For example, AI may automatically detect a change in trends associated with a benchmark score or benchmark scores and provide a course of action with respect to data gathered from the advisor to “course correct” the trends for the respective benchmark score(s). By way of another example, the AI may automatically change a benchmark associated with the benchmark score in real-time, thereby automatically adjusting the associated benchmark score.

FIG. 31 illustrates a flowchart depicting an Advisor Profile create/edit module, according to some embodiments. In some embodiments, the module permits a user to run a history report on the Advisor Profile and/or run Advisor Profile on demand. The module may permit a manager to edit or create an Advisor Profile, either as a new Advisor Profile or from an existing Advisor Profile. In the case of an existing Advisor Profile, the manager may then edit the Advisor Profile, including the basic settings. These basic settings may include but are not limited to name, description, and frequency to be checked. Next, the manager may enter the demographic conditions for the advisee(s) who will be impacted by the Advisor Profile. Next, the manager may enter the performance conditions to be checked. An administrative user may be able to specify any existing advisor, while a managerial user may be limited to seeing selected advisees only, such as those advisees that they oversee. Finally, the manager can select actions to be performed by the Advisor Profile. Multiple actions may be chosen, including but not limited to notifying or emailing the advisor, notifying or emailing the manager, issuing an external API call, invoking a training module for the advisor, or tagging the advisor on a report that can be used to mine data for advisors and groups of advisors.

Should a manager want to edit or create a new Advisor Profile, they may want to choose either to create the Advisor Profile with no assistance or they may choose to clone an existing Advisor Profile from a provided repository. In this example, the manager would clone the Advisor Profile for personal use and/or editing, and then repeat the steps above, i.e., edit the basic settings, advisor demographic conditions, advisor performance conditions, and then select actions. The manager may then enroll this Advisor Profile in the repo for future use. Adding the Advisor Profile to repo may only be available to administrators, while both managers and administrators may access or reuse Advisor Profiles from the repo.

In other examples, where the manager does not want to reuse from the Advisor Profile repository, the manager may create a new Advisor Profile. After creating the new Advisor Profile, the manager may edit the basic settings, advisor demographic conditions, and advisor performance conditions and then select actions.

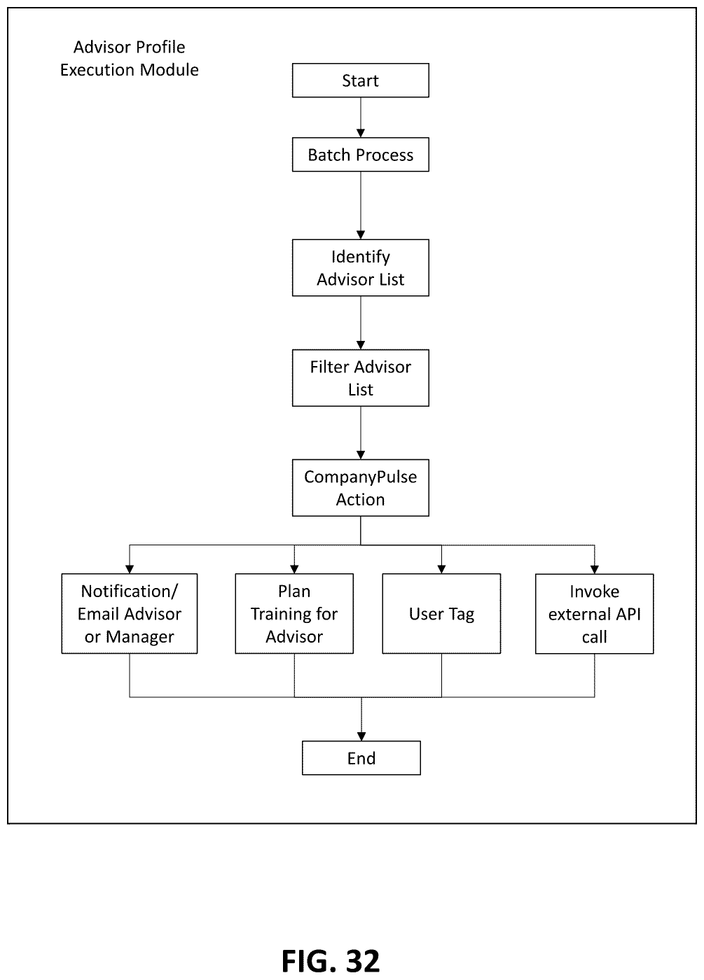

FIG. 32 illustrates a flowchart depicting an Advisor Profile execution module, according to some embodiments. Such a module may begin either immediately in real-time or at a prespecified timeframe/frequency. After identifying the relevant list of advisors relevant to the Advisor Profile, the Advisor Profile may take an action. These actions, like those listed above, may include notifying or emailing the advisor or manager, planning training for an advisor, invoking an external API call, or tagging the advisor on a report that can be used to mine data for advisors and groups of advisors. Over time, data collection paired with AI may be able to notify advisors, managers, and the company when advisor performance trends and/or skill sets are heading in a positive and/or negative direction, and advise the advisor on what areas they need to correct to maximize their performance and probability of success.

FIG. 33 illustrates a flowchart depicting a manager advisees module, according to some embodiments. This module may begin with an advisee index from which the manager may select an advisee. From here, a manager may access the command central modules for an advisee, or generate/retrieve a drilled-down, detailed advisor report. From the drilled-down detailed advisor report, the manager may analyze the advisee's performance. The manager may also review the monthly activity report and/or overall performance rankings for an advisor and, from here, analyze the advisee's performance.

In some embodiments, the manager can access a notification index. Through such a notification index, the manager may create, edit, or delete notifications to a given advisee. According to some embodiments, the manager can access an action plan. Through such an action plan, the manager may create, edit, or delete action plans for a given advisee. The manager may also remove an advisor from the advisee index.

Additional modules may be provided for assessing the performance of the managers in a similar way. In this example, these would be for corporate review of the managers, facilitating the identification of the strengths and weaknesses of individual managers, given their impact and/or influence on the advisors who report to them. In order to accomplish this, such additional modules may provide objective data on a manager's strengths and weaknesses. This information may be used to identify managers who have substandard performance, coach managers on actions needed in order to improve their performance, objectively determine if and when a manager needs to be demoted or terminated, identify managers who excel in specific areas, who may then be recruited to collaborate in training programs to improve other managers' performances, etc.

In order to support this process, the system of the present disclosure may provide data on each manager's advisees. In some embodiments, this data includes the advisor's production relative to their goals, or relative to other advisors with similar demographic profiles. This data may include the advisor's activity and/or activity patterns relative to desired standards, which may simultaneously identify managers whose advisees' performance is consistently substandard. According to some embodiments, the data includes the advisor's activity commitment against their actual activity performance. The data may include the advisor's performance and/or activity ratios relative to benchmarks, wherein managers with advisees who consistently underperform benchmarks are identified as needing to increase training on sales skills in those areas. In some embodiments, the data includes the advisor's historical, current, and projected financial status.

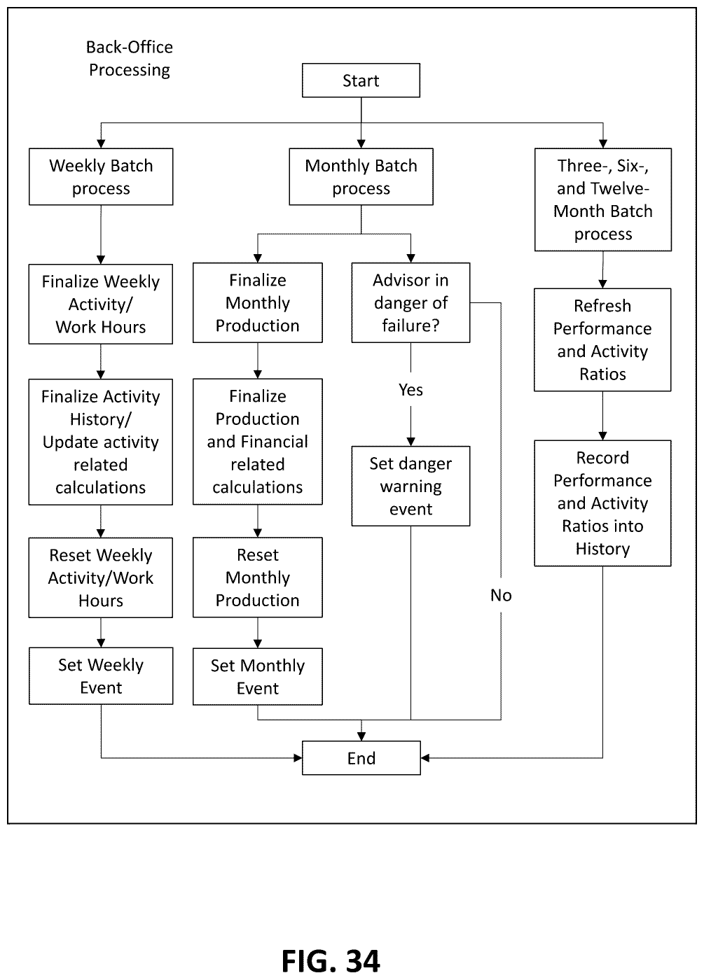

FIG. 34 illustrates a flowchart depicting a back-office processing module, according to some embodiments. In some embodiments, the back-office processing module includes time-based batch processing. For example, the back-office processing module may begin with weekly batch processing. Through weekly batch processing, the user may finalize weekly activity and/or work hours. The system may then finalize the advisor's activity history and/or update activity-related calculations. Finally, the processing module may reset the advisor's weekly activity and/or work hours and then set a weekly event.

In additional examples, the back-office processing module may begin with monthly batch processing. In such monthly batch processing, the processing module may finalize the advisor's monthly production, which may include finalizing production and financial-related calculations. The advisor's monthly production may then be reset, and the processing module may set a monthly review event to be recorded. Additionally, in such monthly batch processing, the system may flag if the advisor is in danger of failure to meet their goals or headed in the direction of a poor financial position. If this occurs, the system may set a danger warning event.

In still further examples, the back-office processing module may begin with three-month, six-month, and/or twelve-month batch processing. In such three-month, six-month, and/or twelve-month batch processing, the back-office processing module may refresh the advisor's performance and/or activity ratios. The back-office processing module may then record such performance and/or activity ratios into the advisor's history for future reference and analysis.

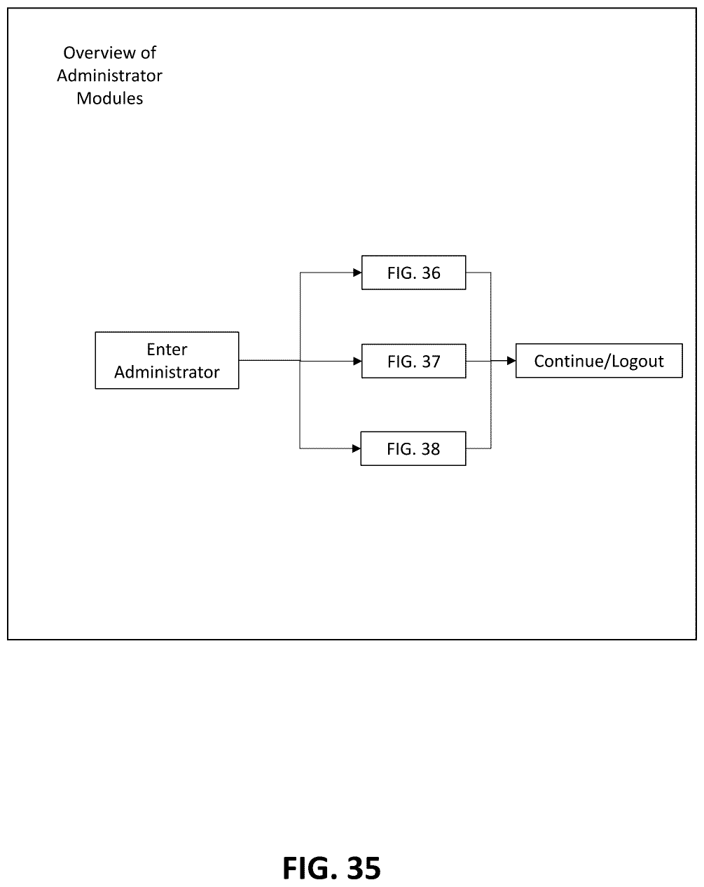

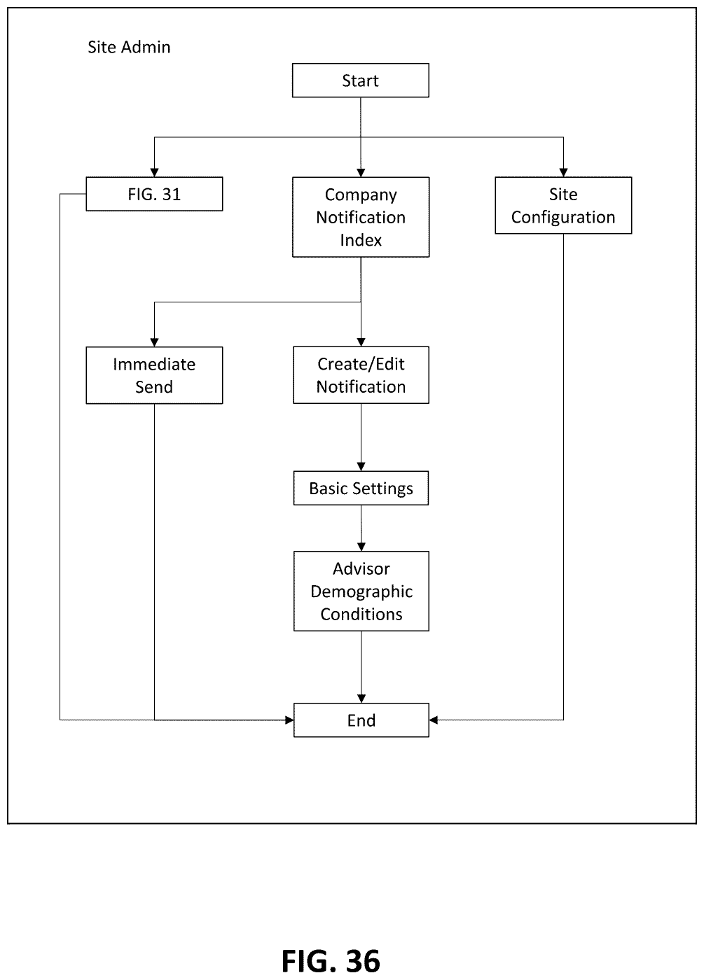

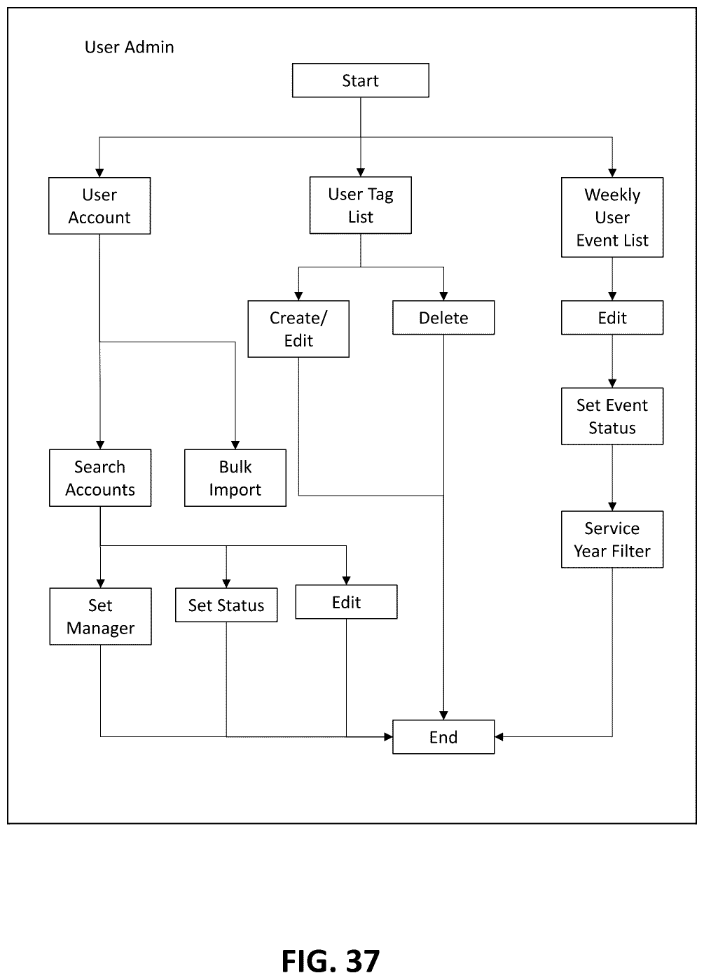

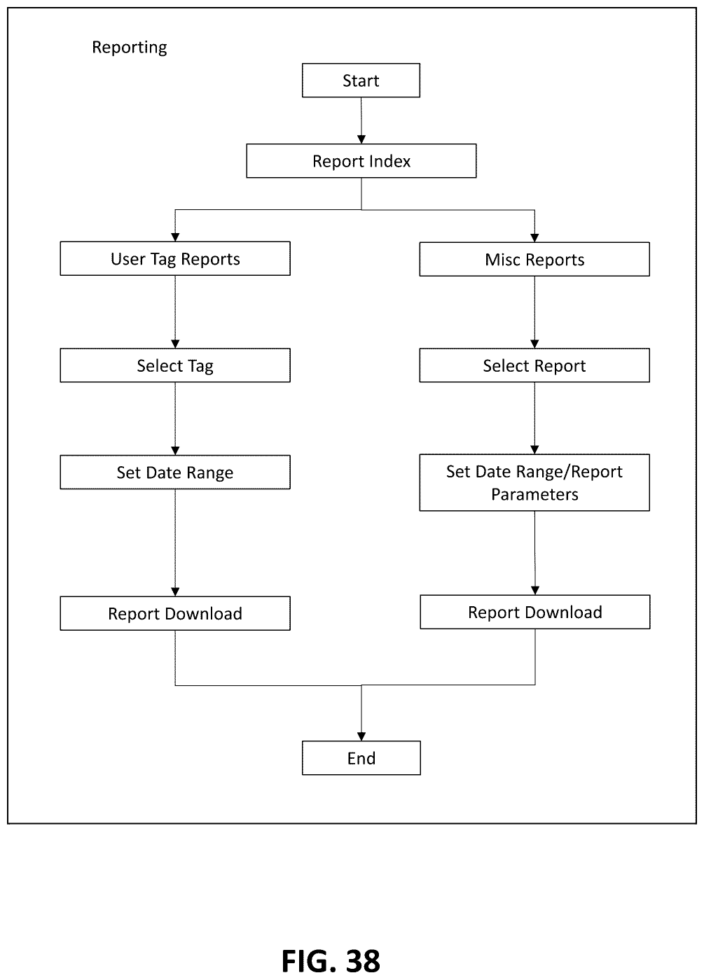

FIG. 35 illustrates a flowchart depicting an administrator overview module, according to some embodiments. Generally, the administrator overview module provides administrators, both site administrators and user administrators, with the ability to directly interact with abilities of the software. This module may take the administrator to a site admin module (as detailed and described in FIG. 36), a user admin module (as detailed and described in FIG. 37), or a reporting module (as detailed and described in FIG. 38). From any of these sections, once completed, an administrator may be brought to a screen to continue (i.e., begin again from entering the administrator overview module or another module as described in this disclosure) or log out from the system as a whole.

FIG. 36 illustrates a site admin module, according to some embodiments. From the site admin module, an administrator may access the Advisor Profile Create/Edit module as detailed and described in FIG. 31 above. The administrator may access site configuration, for editing the site. In some embodiments, the administrator can access the company notification index. From here, the administrator may immediately send a notification, or create or edit notifications. Creating or editing notifications may bring the administrator to a basic settings screen, which may in turn include demographic conditions of the advisor for effectively conveying notifications to the correct demographic.

FIG. 37 illustrates a user admin module, according to some embodiments. From the user admin module, an administrator may access user accounts. The administrator may bulk import user accounts using a data format for storing and exchanging information, such as JavaScript Object Notation (JSON). The administrator may also search the user accounts, in order to edit them, set the status of the user, or set the user to be a manager.

In some embodiments, the administrator may access a user tag list. Here, the administrator may delete user tags, or create and/or edit user tags. User tags may be marked for use by administrators only, or by both administrators and managers.

According to some embodiments, the administrator may access a weekly user event list. For example, advisor events may be possible Monday through Friday, and/or preloaded events may exist on specific days of the week (i.e., Monday, Wednesday, and Friday). In some embodiments, the administrator may edit the weekly user event list. This may include setting the event status (i.e., setting the event status to inactive (a default event in effect) or active). According to some embodiments, the administrator can filter the weekly user event list based on the advisor's years of service.

In conjunction with AI, this may include finding out what events are the most important for advisors to succeed, and informing the organization and/or managers which of these events are the most important. AI may create advisor events based on the prompts that increase sales, skill sets, and the user's probability of success. AI may also customize events for each user based on their demographics, goals, skill sets, activity patterns, trends, etc. with the objective of virtually coaching advisors and/or managers to perform the events and/or tasks that are the most important.

FIG. 38 illustrates a reporting module, according to some embodiments. In some embodiments, the administrator may access a report index. This report may be delivered in a data format for storing and exchanging information, such as JSON, to facilitate easy database use, data mining, and AI training. The reports may be time series-based for a user-specified timeframe.

The administrator may access user tag reports—reports that are available for each defined user tag. In some embodiments, the administrator can select the tag, set the date range, and then download the report. This may be a time series report of a user's entity for each time an advisor was tagged by Advisor Profile within the time range.

The administrator may also access miscellaneous reports. These miscellaneous reports may include enterprise-level reports, real-time query engines containing presets, extensible collections of queries within systems, production reports, activity reports, performance reports, user reports, etc. According to some embodiments, the administrator can select the report, select the date range and/or report parameters, and then download the report.

The software of the present disclosure, when combined with AI, may become a much better coach and/or mentor than a manager can be, so these managers can spend their time and energy on mindset, sales language, high-level business decisions, and other activities that AI is not able to do for the manager. This is because the AI may see connections that a human is unable to see.

This software, in combination with AI, can see what drives different types of users based on the demographics of the user (e.g., first-year advisor, second-year advisor, advisors of specific races, genders, marital status, etc. act in a specific way in response to specific stimuli). The AI may predict, based on historical data related to these demographics, that if an advisor acts in a specific way, they may get specific results that they would not have arrived at should they act in a different way.

A user could then ask the AI for answers to specific questions—such as, what are the benchmark scores for these specific demographics? What activity or activities are needed to succeed? This first-year advisor's performance is declining—what is causing that? Could you provide a list of advisors who are in the danger zone?

What managers have the top-performing first-year advisors? What managers have the worst-performing first-year advisors? What actions are they doing differently to drive this discrepancy? What are the root causes of why managers have top-performing advisors? What are the root causes of why managers have underperforming advisors?

What part of the sales cycle is driving underperformance? (E.g., phoning, fact-finding at discovery meetings, closing, prospecting, etc.) What are the key performance indicators for first-year female advisors who succeed versus those who fail? This manager's advisees' performance is greatly improving—what is the cause?

Through the use of a large quantity of data relating to different metrics and actions taken by those with different demographics, AI can make connections that would be otherwise impossible, or near impossible, to make by a human. Moreover, AI can make predictions on what may lead to success and what may lead to failure and direct advisors, managers, and organizations on what actions to take based on these predictions. By acquiring data points related to metrics and benchmark scores in real-time, the AI may be able to generate action plans for advisors, managers, and organizations in real-time in order to direct them toward higher performance (or higher (i.e., better) benchmark scores), as well as give warnings when they are trending toward lower performance (or lower (i.e., worse) benchmark scores).

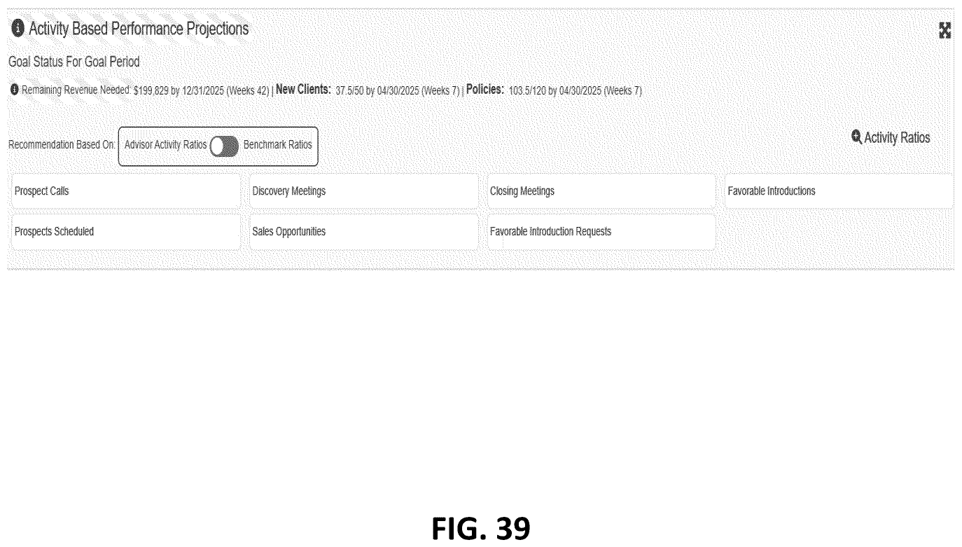

FIGS. 39-44 illustrate graphical representations of a graphical user interface (GUI), according to some embodiments. Specifically, FIG. 39 illustrates a GUI showing possible metrics on which a benchmark score may be calculated, according to some embodiments. As shown in FIG. 39, these metrics may include a number of prospect calls, a number of prospects scheduled, a number of discovery meetings, a number of sale opportunities, a number of closing meetings, a number of favorable introduction requests, and a number of favorable introductions.

The list as shown in FIG. 39 is not exhaustive. For example, the metric(s) may also include a number of activity commitments, business revenue, net profits, hours worked, etc. Any metric for which data may be gathered may be monitored for use in i) determining whether the advisor/manager/organization is successfully hitting their targeted benchmarks (e.g., which may be correlated with a benchmark score, as described herein), and/or ii) determining a modification (e.g., advisor/manager/organization activity and/or benchmark) relating to a given metric that would optimize the advisor/manager/organization in hitting the targeted benchmark for said given metric or any other metric(s).

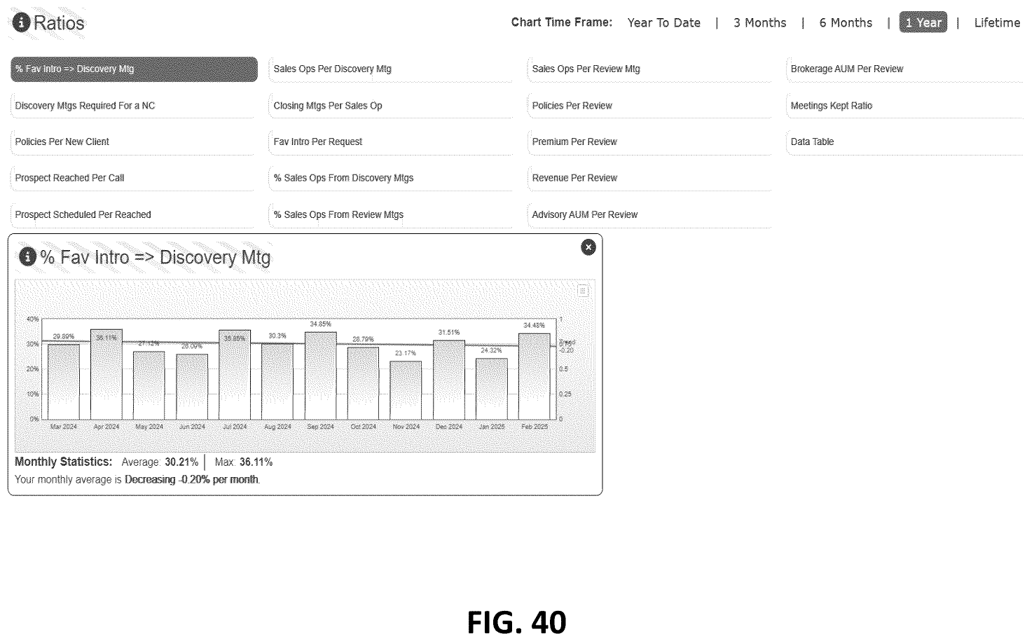

FIG. 40 illustrates a GUI showing possible data that may be calculated for given metrics corresponding to an advisor/manager/organization, and which may be compared with a benchmark to determine a benchmark score for the advisor/manager/organization. As described above with respect to FIG. 39, data may be associated with one metric. FIG. 40 illustrates data that is associated with multiple metrics, which may form a user ratio. In some cases, a metric may be based on two or more other metrics, such as a relationship and/or combination between such two or more metrics (e.g., a ratio between metrics, an additive combination, etc.).

As described herein, the benchmark may be set based on the preferential goals of said advisor/manager/organization and/or automatically updated by the AI in order to optimize the performance and goals of the advisor/manager/organization. As shown in FIG. 40, the combination of metrics (for which data may be obtained, and for which may include a benchmark, thereby facilitating the determination of a benchmark score) may include a percentage of favorable introductions that turned into discovery meetings, a number of discovery meetings required to obtain a new client, an average number of policies obtained for each new client, a number of prospects reached per call made, a number of prospects scheduled per number of prospects reached, a number of sales opportunities per discovery meeting held, a number of closing meetings held per sales opportunity, a number of favorable introductions received per favorable introduction request made, a percentage of sales opportunities from discovering meetings, a percentage of sales opportunities from review meetings, a number of sales opportunities per review meetings, a number of policies per number of review meetings, a number of premiums per number of review meetings, an amount of revenue per number of review meetings, a number of advisory AUM per review meeting, a number of brokerage AUM per review meeting, and a ratio of kept meetings per meeting scheduled.

The list as shown in FIG. 40 is not exhaustive. For example, the data for a given metrics may include a percentage of favorable introductions that resulted in a discovery meeting, or a number of discovery meetings required to obtain a new client, or a percentage of activities an advisor/manager/organization committed to which were executed for a specific time frame, or an amount of business revenue earned per hour worked (or specifically, per revenue generating hour worked), or a net profit to the business from hiring an additional employee versus an expected profit without hiring the additional employee, or a percentage of hours that are worked which are revenue generating hours versus non-revenue generating hours. Any metric for which data may be gathered, as described above in FIG. 39, may be calculated against other metrics to form various percentages and measured against benchmarks for what the advisor/manager/organization should strive to have these metrics reach. Additionally, the metrics may be directly comparable to the benchmarks in some embodiments. As described above, the AI may automatically adjust the benchmarks—and thereby adjust the expected benchmark scores—based on the needs of the advisor/manager/organization, as well as demographic information regarding the advisor/manager/organization or any potential clientele.

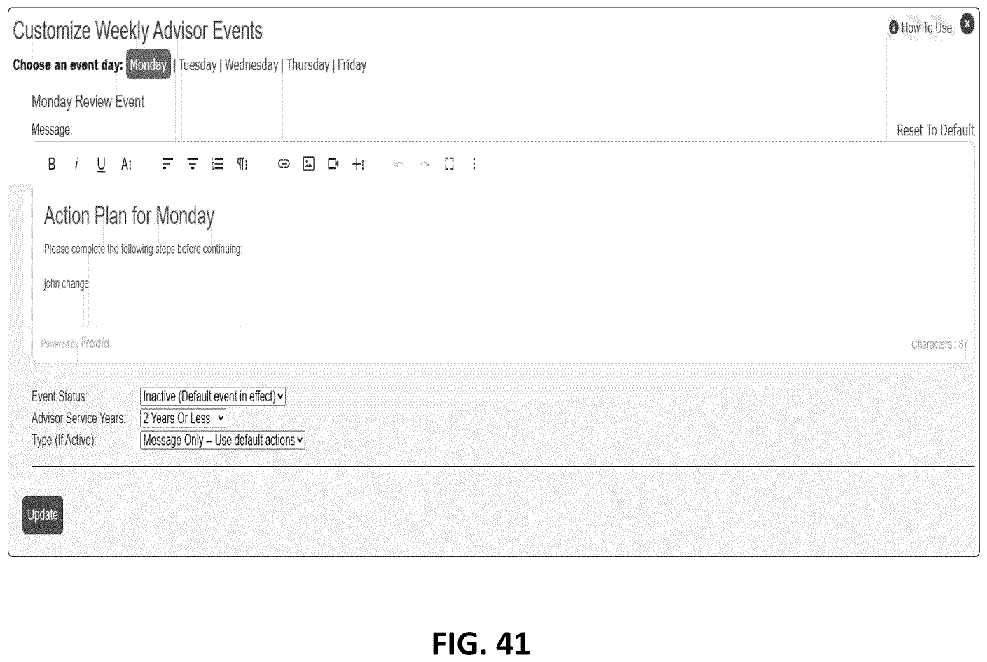

FIG. 41 illustrates a GUI showing a message to be delivered to an advisor, according to some embodiments. In this example, custom action plans may be made to be delivered to an advisor based on their needs and historical data relative to the advisor based on their associated metrics and benchmark scores. A manager may customize the action plan themselves. In embodiments including AI, the AI may take into consideration demographic information associated with the advisor (or prospects associated with upcoming prospect meetings) and customize the action plan (e.g., course of action) with these considerations accounted for.

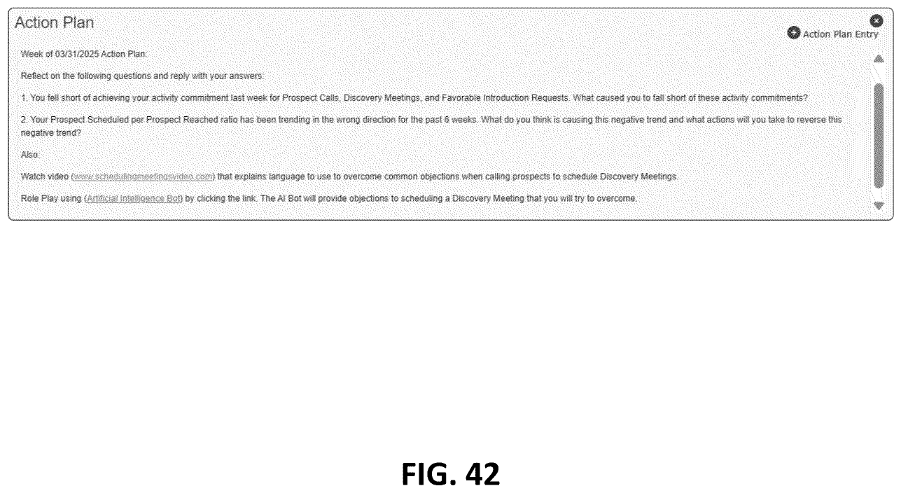

FIG. 42 illustrates a GUI showing a message to be delivered to an advisor in additional or alternative embodiments. As shown in FIG. 42, the AI can coach an advisor through having the advisor reflect on their actions and results via a dialogue, in addition to or instead of giving the advisor information outright. For example, the AI may instruct the advisor on their shortcomings and ask the advisor questions regarding such shortcomings. The advisor, upon reflection, may form a dialogue with the AI in order to determine what they are doing wrong, thereby teaching the advisor to catch their shortcomings with less involvement from outside sources. Also shown in FIG. 42, the AI may provide customized presentations to the advisor to assist with their training.

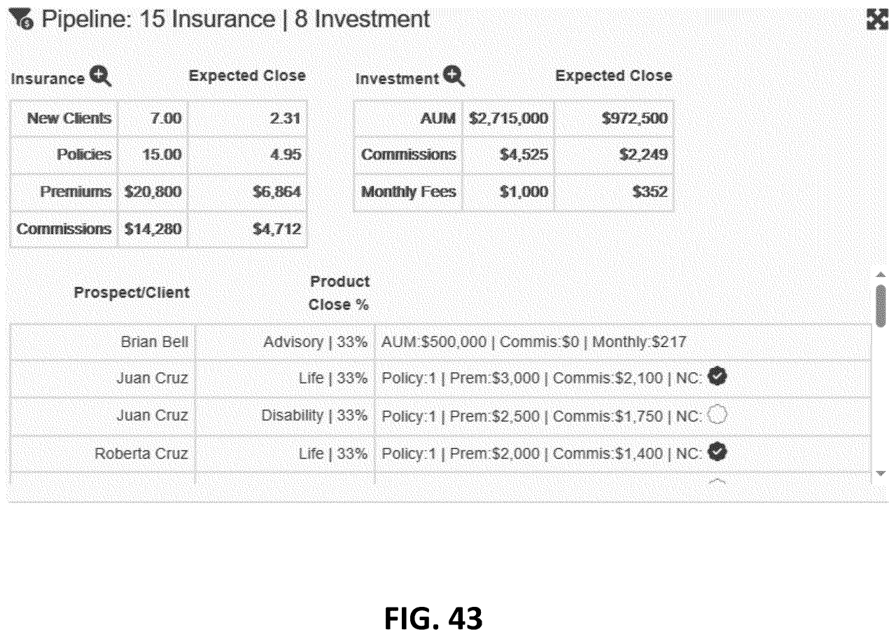

FIG. 43 illustrates a GUI showing expected metrics for an advisor to obtain (e.g., benchmarks) in order to attain their target benchmark scores, according to some embodiments. As shown in FIG. 43, an advisor may be notified and/or provided with a list of upcoming events associated with metrics from which their benchmark score is derived. In this figure, such metrics include how many potential clients they are meeting with, how many policies they are discussing, how much value in premiums they are discussing, a value of commissions they would receive from said premiums (on the insurance side), a value of AUM, a value of commissions they would receive from said AUM, and a value of monthly fees (on the investment side). These upcoming events are displayed next to expected metrics that would see the advisor reaching or exceeding their set benchmark score, should they exceed the expected metric.

For example, if an advisor is meeting with seven new prospective clients, the benchmark may be closing with 2.31 new clients (or 33% of prospective clients). A better-performing or more successful advisor may exceed this benchmark, closing with three or more prospective clients of the seven, while a worse-performing or less successful advisor may fall short of this benchmark, closing with two or fewer prospective clients. Stated another way, a user with data that is greater than 2.31 correlates with a better benchmark score as described herein.

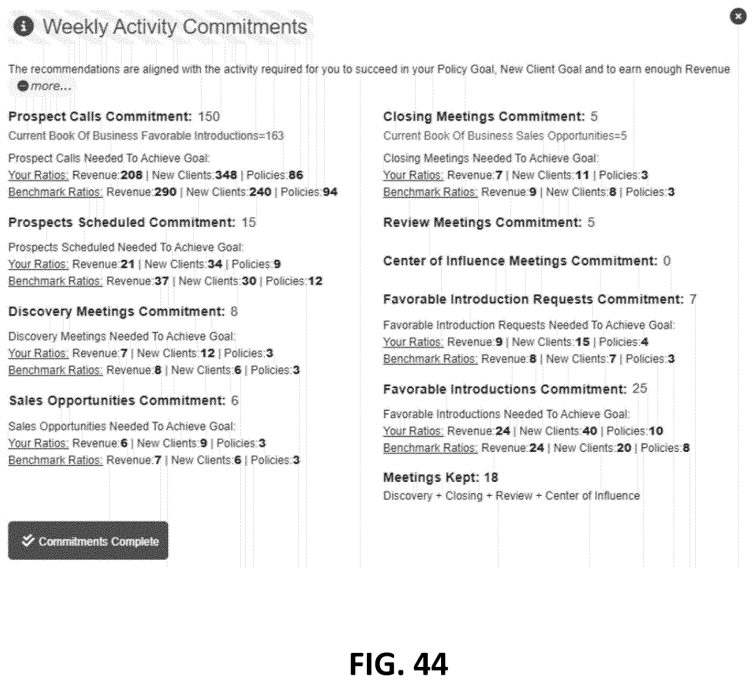

FIG. 44 illustrates a GUI showing activity commitments, according to some embodiments. As shown in FIG. 44, a user can make commitments to different activities (or metrics). Such commitments may include, as a non-exhaustive list, prospect calls, prospects scheduled, discovery meetings, sales opportunities, closing meetings, review meetings, center of influence meetings, favorable introduction requests, favorable introductions, and meetings kept. The AI may also automatically apply commitments for the user based on the user's set goals, historical trends, and demographic information.

The AI may additionally monitor the user's ratios in comparison to the user-specific benchmark ratios in order to inform the user of how many activities they must perform within a certain category in order to reach their goals (i.e., have a better benchmark score). For example, the user may commit to making 150 prospect calls in a week. The AI may inform the user, based on historical data points associated with the user, or other users with similar demographics, the required number of activities needed in order to meet their revenue, new client, and policy goals. These user ratios may additionally be measured against overarching benchmark ratios for these activity goals.

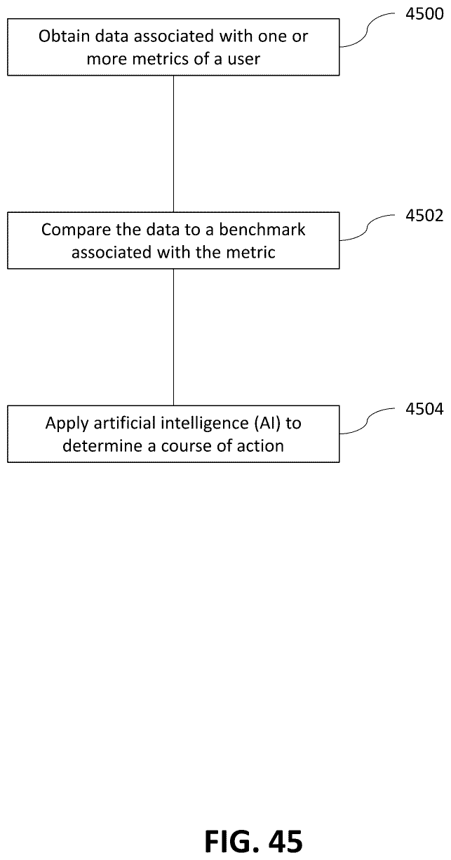

FIG. 45 illustrates a flowchart depicting a method of using AI to determine a course of action, according to some embodiments. In some embodiments, the method includes obtaining data associated with one or more metrics of a user (at step 4500). According to some embodiments, this includes input from the user. Additionally, or alternatively, the data may be automatically gathered. For example, the data may be automatically gathered using a software, as described herein, configured to monitor and/or obtain information for certain metrics associated with a user (e.g., time spent on a given module, training performed and/or completed, calls made, etc.). As described herein, the software may use AI to obtain said data.

In some embodiments, the user is an advisor, and the metric(s) may include, as a non-exhaustive list of examples, the advisor's i) activity patterns, ii) productivity, iii) skill set, iv) responsiveness to notifications, v) need to implement corrective actions, vi) personal savings goals, vii) professional savings goals, viii) major purchase goals, ix) professional production goals, x) personal financial position, xi) professional financial position, or xii) combinations thereof. The personal financial position and professional financial positions may be represented in the cash flow modules (as shown and described in FIG. 19 above) and the balance sheet modules (as shown and described in FIG. 20 above).

According to some embodiments, the user is a manager, and the metric may include, as a non-exhaustive list of examples, i) a productivity of the manager (i.e., recruiting advisees and/or retaining advisees), ii) activity patterns of the manager's one or more advisees, iii) common strengths of the manager's one or more advisees, iv) common weaknesses of the manager's one or more advisees, or v) combinations thereof. The metric may additionally include a productivity of the manager's one or more advisees and/or productivity patterns of the manager's one or more advisees. Common strengths and weaknesses may pertain to skillsets, productivity, and sales of the manager and/or the manager's advisees. This may permit the facilitation of the manager personalizing their mentoring to a specific subset of advisees, such as via the advisee(s) service year, demographics, goals, financial needs, etc.

In some embodiments, the software and AI of the present disclosure permit the manager to customize their mentoring to each advisee based on demographics and/or specific, user-selected subsets of their advisee list.

The user may be an organization, and the metric may correspond to collective and/or any combination of metrics of advisors and managers that are a part of the organization. The productivity of the manager may include time efficiency added to the manager and their team by the software and AI of the present disclosure, as well as the production of the manager's one or more advisees.

According to some embodiments, the common strengths and common weaknesses are activity levels, activity commitment follow-through, and/or skill sets (i.e., advisee(s) benchmark score compared to a benchmark ratio). The metric may be i) a time of interaction with a module of a software application, ii) a distribution of modules of a software application interacted with, iii) a usage pattern of interacting with modules of a software application, iv) an order of modules of a software application accessed, v) items within a module of a software application interacted, vi) a pattern of use of a software application, vii) a responsiveness to notifications, or viii) combinations thereof. In some embodiments, the AI is configured to improve the way in which the notifications are sent (e.g., via a determined course of action, as described herein). According to some embodiments, the AI is configured to customize the notifications to the user.

According to some embodiments, the method includes comparing the data to a benchmark associated with the metric (at step 4502). This may include determining a benchmark score. In some embodiments, the benchmark score includes subtracting the data from the benchmark, and a benchmark score that is greater than or equal to zero is associated with a better benchmark score. According to some embodiments, the benchmark score includes dividing the data by the benchmark, and a benchmark score that is greater than or equal to one is associated with a better benchmark score. The benchmark may be a threshold against which the data is measured to determine if a given threshold has been met. For example, the benchmark score may include forming an inequality between the data and the benchmark and returning a Boolean “true” when the data is greater than or equal to the benchmark and a Boolean “false” when the data is less than the benchmark, and a Boolean “true” is associated with a better benchmark score. As described herein, the method may include comparing one or more data associated with respective metric(s), such as, for example, comparing a plurality of different data for different metrics, any number of which may have a respective benchmark, so as to determine a respective plurality of benchmark scores.

The method may include applying AI to determine a course of action (at step 4504). In some embodiments, the course of action is based on the benchmark score and demographic information. The course of action may include one of i) calibrating the benchmark, ii) determining an activity (which may include determining a new activity for a user to perform, or performing a previous activity differently) to adjust future data associated with the metric, or iii) both. According to some embodiments, this course of action modifies the benchmark score.

As described herein, calibrating the benchmark for a metric may include determining a new benchmark, via the AI, which may incorporate i) historical data relating to the metric and/or one or more other metrics, and/or ii) demographic information, wherein the AI is configured to determine trends that would adjust the benchmark (e.g., calibrate) so as to provide a tailored goal specifically for the user. Accordingly, the AI may be able to take into account demographic information such as service year, marital status, location, etc. to vary the benchmark for users (e.g., advisors) who differ in this information.

For any given metric, the AI may independently identify a benchmark based on a specific collection of demographic information, which is not limited to the user but may include others or data related to others (e.g., a customer, potential client, etc.). Accordingly, it is possible for the benchmarks for certain metric(s) to rise and/or become more advanced, while the benchmarks for other metric(s) lower and/or become easier, based on the AI computation according to the specific combination of data and demographic information. In some embodiments, the AI may take into account other factors, external to demographic information, such as, for example, a natural disaster, a stock market crash, a new government regulation or other implementation, an increase in interest rates, etc., all of which may be used to calibrate the benchmark for any given metric.

The AI may also calibrate the benchmarks for one or more metrics in real-time, based on real-time updates to data, demographic information, and/or any other factors.

As described herein, determining an activity to adjust future data associated with a given metric may include determining one or more new activities for a user to perform, and/or determining that the user should perform one or more previously performed activities differently. The new activity may include any activity described herein. Performing an activity differently may include comparisons with users having data for the given metric who had higher or better benchmark scores. Performing an activity differently may take into account demographic information before performing any such comparisons. The AI may incorporate i) historical data relating to the metric and/or one or more other metrics, and/or ii) demographic information, which is not limited to the user but may include others or data related to others (e.g., a customer, potential client), wherein the AI is configured to determine trends tailored specifically for the user to help optimize the data for a given metric. Accordingly, the AI may be able to take into account demographic information such as service year, marital status, location, etc. to determine an activity that comparable users found success or better data output for a given metric.

The AI may also determine an activity for one or more metrics in real-time, based on real-time updates to data, demographic information, and/or any other factors.

In some embodiments, the AI may be configured to optimize the adjustment of future data for one or more metrics, so as to prioritize the benchmark scores for certain metrics. This may include situations where, for example, certain activities are found to have inverse effects on the data of different metrics, such that the AI may be configured to favor certain metrics, based on, for example, a predetermined priority hierarchy for one or more metrics. Additionally, or alternatively, the AI may be configured to favor certain metrics based on maximizing the number of metrics for which the benchmark scores are optimized.

In some embodiments, modifying the benchmark score includes optimizing the benchmark score. The demographic information may be related to the user. In additional or alternative embodiments, the demographic information is related to another person with relation to the user and/or a metric associated with the user.

According to some embodiments, the demographic information includes i) age, ii) gender, iii) race, iv) experience level, v) highest level of education, vi) marital status, vii) family status, viii) household income, ix) geographic location, x) occupation, xi) origin, or xii) combinations thereof. The demographic information may include a collection of historical demographic information. For example, in some embodiments, the system described herein may include for any number of metrics, a collection of historical data and corresponding demographic information associated with each of said historical data. Accordingly, using AI and the collection of historical data, a system described herein may be able to identify trends or other patterns based on countless combinations of demographic information with various metrics. In some embodiments, the AI is configured to update the course of action based on the collection of historical data.

According to some embodiments, determining the course of action includes using data associated with one or more better benchmark scores to provide instruction to the user when the data of the user is associated with a worse benchmark score. The AI may be configured to determine commonalities between users associated with better benchmark scores. This may occur en masse and/or segmented by an arbitrary (or AI-dictated) combination of demographics (as detailed above).

In some embodiments, determining the course of action includes using the commonalities between users associated with better benchmark scores. According to some embodiments, the course of action is i) triggering training or ii) other remediation when the metric of the user is associated with a worse benchmark score. The training may be a corrective action. In some embodiments, the AI is configured to determine a need for training in real-time.

According to some embodiments, the AI is configured to create a presentation for the user. The presentation may be a video presentation. In some embodiments, the presentation is interactive. According to some embodiments, the presentation is tailored to the user based on i) the data, ii) the metric, iii) the benchmark score, iv) the user's demographics, or v) combinations thereof. The AI may be configured to provide training materials to the user.

In some embodiments, the user is a manager, and the AI is configured to find materials explaining how to i) inspire, ii) motivate, iii) inform, iv) educate, v) improve skill sets, or vi) combinations thereof an advisor. According to some embodiments, the user is a manager, and the AI is configured to generate materials explaining how to i) inspire, ii) motivate, iii) inform, iv) educate, v) improve skill sets, or vi) combinations thereof an advisor.

The user may be an organization, and the AI may be configured to find materials explaining how to i) inspire, ii) motivate, iii) inform, iv) educate, v) improve skill sets, or vi) combinations thereof a manager and/or advisor. In some embodiments, the user is an organization, and the AI is configured to generate materials explaining how to i) inspire, ii) motivate, iii) inform, iv) educate, v) improve skill sets, or vi) combinations thereof a manager and/or advisor.

According to some embodiments, the materials are i) videos, ii) processes, iii) articles, iv) websites, v) social media posts, vi) internal company posts, vii) podcasts, or viii) combinations thereof. The user may be a manager, and the AI may be configured to facilitate a growth of the manager's i) training, ii) coaching, or iii) combinations thereof.

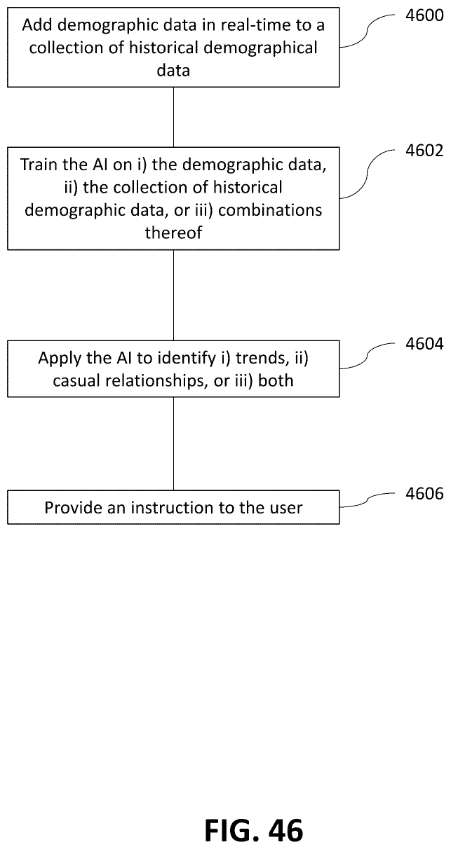

FIG. 46 illustrates a flowchart depicting additional methods of using AI to determine a course of action, according to some embodiments. In some embodiments, the method includes adding demographic information in real-time to a collection of historical demographical data (at step 4600). This may be based on the metric of the user.

According to some embodiments, the AI is configured to update a collection of historical data with the data with respect to the demographic information in real-time. The user may be a first user in a plurality of users, and the AI may be configured to update a collection of historical data based on data points associated with each user of the plurality of users with respect to the demographic information in real-time.

According to some embodiments, the method includes training the AI on i) the demographic information, ii) the collection of historical demographic information, or iii) combinations thereof (at step 4602).

The method may include applying the AI to identify i) trends, ii) relationships, or iii) both (at step 4604). According to some embodiments, applying the AI occurs with respect to the demographic information. The AI may be configured to identify when the trends are moving toward i) a better benchmark score, ii) a worse benchmark score, or iii) combinations thereof.

According to some embodiments, the software and AI of the present disclosure are able to identify the relationship of why a benchmark score is improving or becoming worse so that the user is able to figure out what needs improvement. In some embodiments, the AI compares the trends in the data to a collection of historical data. In some embodiments, the AI is configured to identify trends in the data based on a collection of historical data for a plurality of metrics, all of which are being updated in real-time. Thus, the AI may be able to adjust a course of action for a user (e.g., advisor, manager, organization) based on changes occurring in real-time, such as environmental and/or societal changes. For example, a natural disaster, stock market crash, or new residential developments in a given area may all be changes that ultimately may impact data for one or more metrics. Accordingly, the AI may be able to identify such trends and determine a course of action based on comparable historical data and/or identify an optimal combination of calibrating the benchmark for one or more metrics, as well as determining a new activity (e.g., performing a new activity or modifying a performance of a previous activity) that would optimize the benchmark scores for one or more metrics.

In some embodiments, the method includes providing an instruction to the user (at step 4606). According to some embodiments, the AI is configured to inform the user when it would be profitable to hire an employee. The AI may be configured to change the culture of an organization. This may be accomplished through using AI to enable advisors, managers, and/or the organization to share best practices related to training and/or coaching strategies (i.e., sharing the best strategies from top advisors and/or managers in specific areas (sales, skill sets, activity, activity patterns, etc.)), demographics best suited to become advisors and/or managers so the organization can better pinpoint who they are recruiting for specific roles. AI may also enable advisors, managers, and/or the organization to more quickly identify advisors and managers who are trending toward failure, as failing advisors and/or managers sticking around for too long harms the organizational culture—therefore having them leave the organization sooner would help the organizational culture. AI may further deobfuscate what is necessary to succeed through finding benchmark activity levels necessary for success, and informing advisors and/or managers what activity levels they need to be at to succeed in their personal and professional goals and financial needs. The AI may also be able to inform the organization what its company initiatives should look like—for example, what demographics of clients increase the organization's profitability and/or what demographics of advisors attract specific demographics of clients.

In some embodiments, the AI is configured to identify demographics associated with better benchmark scores for a given metric. According to some embodiments, the AI is configured to identify advisors best suited to become managers based on one or more of the advisor's benchmark scores.

The AI may be configured to identify advisors best suited to become managers based on a combination of the demographic information and one or more of the advisor's benchmark scores. In some embodiments, the AI is configured to predict i) a success or ii) a failure of an advisor based on skills displayed by the advisors.

The preceding method steps may also be performed via a non-transitory, computer-readable media, causing a processor to perform said aforementioned method steps.

Some of the components listed herein use the same number from figure to figure. It should be appreciated these components use the same numbers solely for ease of reference and to facilitate comprehension for the reader. While these components may use the same numbers, differences may be present in these components as illustrated in the various figures in which they appear and as described in the specification herein.

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

The foregoing may be accomplished through software code running in one or more processors on a communication device in conjunction with a processor in a server running complementary software code.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

It is appreciated that in order to practice the method of the foregoing as described above, it is not necessary that the processors and/or the memories of the processing machine be physically located in the same geographical place. That is, each of the processors and the memory (or memories) used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the foregoing, be performed by a single component. Further, the processing performed by one distinct component as described above may be performed by two distinct components. In a similar manner, the memory storage performed by two distinct memory portions, as described above, may, in accordance with a further embodiment of the foregoing, be performed by a single memory portion. Further, the memory storage, performed by one distinct memory portion, as described above, may be performed by two memory portions.

Further, various technologies may be used to provide communication between the various processors and/or memories, as well as to allow the processors and/or the memories of the foregoing to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the foregoing. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software may instruct the processing machine what to do with the data being processed.

Further, it is appreciated that the instructions or set of instructions used in the implementation and operation of the foregoing may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the foregoing. Illustratively, the programming language used may include assembly language, Ada, APL, Basic, C, C++, COBOL, dBase, Forth, Fortran, Java, Modula-2, Pascal, Prolog, Python, REXX, Visual Basic, and/or JavaScript, for example. Further, it is not necessary that a single type of instruction or single programming language be utilized in conjunction with the operation of the system and method of the foregoing. Rather, any number of different programming languages may be utilized as is necessary and/or desirable.

Also, the instructions and/or data used in the practice of the foregoing may utilize any compression or encryption technique or algorithm, as may be desired. An encryption module might be used to encrypt data. Further, files or other data may be decrypted using a suitable decryption module, for example.

As described above, the foregoing may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the foregoing may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the foregoing.

Further, the memory or memories used in the processing machine that implements the foregoing may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the foregoing, a variety of “user interfaces” may be utilized to allow a user to interface with the processing machine or machines that are used to implement the foregoing. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the foregoing, it is not necessary that a human user actually interact with a user interface used by the processing machine of the foregoing. Rather, it is also contemplated that the user interface of the foregoing might interact, i.e., convey and receive information, with another processing machine, rather than a human user. Accordingly, the other processing machine might be characterized as a user. Further, it is contemplated that a user interface utilized in the system and method of the foregoing may interact partially with another processing machine or processing machines, while also interacting partially with a human user.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

1-30. (canceled)

31. A method, comprising:
obtaining data associated with a metric of a user;
comparing the data to a benchmark associated with the metric, thereby determining a benchmark score; and
applying artificial intelligence (AI) to determine a course of action based on the benchmark score and demographic information;
the course of action comprising i) calibrating the benchmark, ii) determining an activity to adjust future data associated with the metric, or iii) both, so as to modify the benchmark score.

32. The method of claim 31, wherein modifying the benchmark score comprises optimizing the benchmark score.

33. The method of claim 31, wherein the demographic information is i) related to the user, ii) related to another person with relation to the user, or iii) both.

34. The method of claim 31, wherein the demographic information comprises i) age, ii) gender, iii) race, iv) experience level, v) highest level of education, vi) marital status, vii) family status, viii) household income, ix) geographic location, x) occupation, xi) origin, or xii) combinations thereof.

35. The method of claim 31, wherein the demographic information comprises a collection of historical demographic information.

36. The method of claim 35, further comprising adding demographic information in real-time to the collection of historical demographic information based on the metric of the user.

37. The method of claim 35, further comprising training the AI on i) the demographic information, ii) the collection of historical demographic information, or iii) combinations thereof.

38. The method of claim 31, wherein obtaining data associated with the metric of the user comprises i) input from the user, ii) automatically gathering the data via the AI, or iii) combinations thereof.

39. The method of claim 31, wherein the user is an advisor, and wherein the metric comprises the advisor's i) activity patterns, ii) productivity, iii) skill set, iv) responsiveness to notifications, v) need to implement corrective actions, vi) personal savings goals, vii) professional savings goals, viii) major purchase goals, ix) professional production goals, x) personal financial position, xi) professional financial position, or xii) combinations thereof.

40. The method of claim 31, wherein the user is a manager, and wherein the metric comprises i) a productivity of the manager, ii) activity patterns of the manager's one or more advisees, iii) common strengths of the manager's one or more advisees, iv) common weaknesses of the manager's one or more advisees, or v) combinations thereof.

41. The method of claim 31, wherein the user is an organization, and wherein the metric corresponds to collective metrics of advisors and managers that are a part of the organization.

42. The method of claim 31, further comprising applying the AI to identify i) trends, ii) relationships, or iii) both in the data with respect to the demographic information.

43. The method of claim 42, wherein the AI is configured to identify when the trends are moving toward i) a better benchmark score, ii) a worse benchmark score, or iii) combinations thereof.

44. The method of claim 42, wherein the AI compares the trends in the data to a collection of historical data.

45. The method of claim 31, wherein the AI is configured to update a collection of historical data with the data with respect to the demographic information in real-time.

46. The method of claim 45, wherein the user is a first user in a plurality of users, and wherein the AI is configured to update the collection of historical data based on data points associated with each user of the plurality of users with respect to the demographic information in real-time.

47. The method of claim 45, wherein the AI is configured to update the course of action based on the collection of historical data.

48. The method of claim 31, wherein determining the course of action comprises using data associated with one or more better benchmark scores to provide instruction to the user when the data of the user is associated with a worse benchmark score.

49. The method of claim 31, wherein the AI is configured to determine commonalities between users associated with better benchmark scores.

50. The method of claim 49, wherein determining the course of action comprises using the commonalities between users associated with better benchmark scores.
